(19) United States
(12) Patent Application Publication
(10) Pub. No.: US 2023/0118141 A1
(43) Pub. Date: Apr. 20, 2023

(54) COMMUNICATION METHOD AND APPARATUS

(71) Applicant: HUAWEI TECHNOLOGIES CO., LTD., Shenzhen (CN)

(72) Inventors: Chunxu JIAO, Shanghai (CN); Zhengzheng XIANG, Shanghai (CN); Lei LU, Shanghai (CN)

(21) Appl. No.: 17/994,041

(22) Filed: Nov. 25, 2022

Related U.S. Application Data
(63) Continuation of application No. PCT/CN2021/092746, filed on May 10, 2021.

(30) Foreign Application Priority Data
May 27, 2020 (CN) 202010462497.4

(51) Int. Cl. H04L 5/00; H04W 72/40

(52) U.S. Cl. CPC H04L 5/0051; H04L 5/0092; H04W 72/40

(57) ABSTRACT

A communication method and an apparatus relate to fields such as V2X, intelligent connected vehicles, intelligent driving, and assisted driving, to resolve a technical problem that a current SL lacks an indication of an SL TCI identifier. The SL TCI identifier is able to be implemented in at least two ways. An explicit indication is able to be used. A first terminal apparatus sends first indication information to a second terminal apparatus. The second terminal apparatus determines the SL TCI identifier of the first reference signal based on the first indication information. Alternatively, a first terminal apparatus generates a first signal based on an SL TCI identifier of the first signal, and sends the first signal to a second terminal apparatus. Then, the second terminal apparatus determines the SL TCI identifier of the first signal based on the first signal.

### CROSS-REFERENCE TO RELATED APPLICATIONS

This application is a continuation of International Application No. PCT/CN 2021/092746, filed on May 10, 2021, which claims priority to Chinese Patent Application No. 202010462497.4, filed on May 27, 2020. The disclosures of the aforementioned applications are hereby incorporated by reference in their entireties.

### BACKGROUND

With further evolution of a multiple-input multiple-output (multiple-input multiple-output, MIMO) technology, technologies such as multiple-transmission and reception point (multiple-transmission and reception point, Multi-TRP), multiple-panel (multiple-panel, Multi-panel), and multiple-beam (multiple-beam, Multi-beam) are proposed in a Uu air interface of new radio (new radio, NR).

When the foregoing MIMO technology is used, a receiving end needs to be capable of distinguishing between signals sent by different TRPs, panels, or beams. Therefore, two concepts are used in NR: quasi co-located (quasi co-located, QCL) and a transmission configuration indication (transmission configuration indication, TCI). In NR, the TCI indicates a QCL relationship between two reference signals (reference signals, RSs).

In an NR system, in addition to the Uu air interface, there is a PC5 interface. The PC5 interface is a communication interface between terminal apparatuses. A transmission link in the PC5 interface is defined as a sidelink (sidelink, SL). However, currently, there is still a lack of a method of indicating an SL TCI identifier. This hinders use of the MIMO technologies such as the multiple-panel and the multiple-beam in the PC5 interface.

### SUMMARY

Embodiments described herein provide a communication method and an apparatus, to indicate an SL TCI identifier.

According to a first aspect, a communication method is provided. The method is performed by a first terminal apparatus. The first terminal apparatus is a terminal device, or is a component (for example, a chip, a circuit, or another component) configured in the terminal device. The method includes: The first terminal apparatus sends first indication information to a second terminal apparatus. The first indication information indicates a first sidelink transmission configuration indication SL TCI identifier of a first reference signal, and the first SL TCI identifier indicates a channel feature of a first channel for transmitting the first reference signal. The first terminal apparatus sends the first reference signal to the second terminal apparatus on the first channel.

According to the foregoing method of indicating the SL TCI, a disadvantage that a current SL lacks a method of indicating an SL TCI identifier is compensated for. Further, based on the foregoing provided simplified definition of the SL TCI identifier, in comparison with the Uu air interface, signaling overheads of indicating the TCI is reduced, to resolve a technical problem that a TCI indication method is excessively complex because there are excessively many QCL types in the Uu air interface.

In at least one embodiment, the first reference signal includes a physical sidelink shared channel demodulation reference signal, a physical sidelink control channel demodulation reference signal, or a sidelink channel state information reference signal, and the first indication information is carried in second-stage sidelink control information.

In at least one embodiment, the method further includes: The first terminal apparatus determines N^{SL-TCI} SL TCI identifiers. N^{SL-TCI} is a positive integer greater than or equal to 1, and the first SL TCI identifier belongs to the N^{SL-TCI} SL TCI identifiers. The first terminal apparatus sends first configuration information to the second terminal apparatus. The first configuration information is for configuring theN^{SL-TCI} SL TCI identifiers for the second terminal apparatus.

According to the foregoing method, the first terminal apparatus determines the N^{SL-TCI} SL TCI identifiers based on a quantity of panels, transmission beams, antennas, or the like. Then, the first terminal apparatus configures the N^{SL-TCI} SL TCI identifiers for the second terminal device. The first terminal device configures different SL TCI identifiers for the terminal device based on different conditions of the first terminal device, so that adaptability is high and the method of indicating the SL TCI identifier is flexible.

In at least one embodiment, that the first terminal apparatus determines N^{SL-TCI} SL TCI identifiers includes:
determining the N^{SL-TCI} SL TCI identifiers based on a quantity of panels,
transmission beams,
or antennas of the first terminal apparatus.

In at least one embodiment, the first configuration information is carried in a radio resource control message of a PC5 interface, or the first configuration information is carried in a media access control (MAC) control element of a PC5 interface.

In at least one embodiment, the method further includes: The first terminal apparatus determines N^{SL-TCI} SL TCI identifiers based on configuration information of a sending resource pool. N^{SL-TCI} is a positive integer greater than or equal to 1, and the first SL TCI identifier belongs to the N^{SL-TCI} SL TCI identifiers.

According to the foregoing method, the first terminal apparatus and the second terminal device separately determines the N^{SL-TCI} SL TCI identifiers based on configuration information of a sending resource. Configuration is not performed by using additional signaling, so that signaling overheads are reduced.

According to a second aspect, a communication method is provided. The method is performed by a second terminal apparatus. The second terminal apparatus is a terminal device, or is a component (for example, a chip, a circuit, or another component) configured in the terminal device. The method includes: The second terminal apparatus receives first indication information from a first terminal apparatus. The first indication information indicates a first sidelink transmission configuration indication SL TCI identifier of a first reference signal, and the first SL TCI identifier indicates a channel feature of a first channel for transmitting the first reference signal. The second terminal apparatus receives the first reference signal from the first terminal apparatus on the first channel.

In at least one embodiment, the first reference signal includes a physical sidelink shared channel demodulation reference signal, a physical sidelink control channel demodulation reference signal, or a sidelink channel state information reference signal, and the first indication information is carried in second-stage sidelink control information.

In at least one embodiment, the method further includes: The second terminal apparatus receives first configuration information from the first terminal apparatus. The first configuration information is for configuring N^{SL-TCI} SL TCI identifiers for the second terminal apparatus, and the first SL TCI identifier belongs to the N^{SL-TCI} SL TCI identifiers. The second terminal apparatus determines the N^{SL-TCI} SL TCI identifiers based on the first configuration information.

In at least one embodiment, the first configuration information is carried in a radio resource control message of a PC5 interface, or the first configuration information is carried in a media access control (MAC) control element of a PC5 interface.

In at least one embodiment, the method further includes: The second terminal apparatus determines N^{SL-TCI} SL TCI identifiers based on configuration information of a receiving resource pool. N^{SL-TCI} is a positive integer greater than or equal to 1, and the first SL TCI identifier belongs to the N^{SL-TCI} SL TCI identifiers.

According to a third aspect, a communication method is provided. The method is performed by a first terminal apparatus, and includes: The first terminal apparatus determines a first sidelink transmission configuration indication SL TCI identifier of a first signal. The first SL TCI identifier indicates a channel feature of a first channel for transmitting the first signal. The first terminal apparatus determines the first signal based on the first SL TCI identifier. The first terminal apparatus sends the first signal to a second terminal apparatus on the first channel.

According to the foregoing method of indicating the SL TCI identifier, not only a technical disadvantage of a lack of the SL TCI identifier in an SL is compensated for, but also signaling overheads of indicating the TCI are reduced in comparison with a Uu air interface. Further, in this embodiment, because the first terminal apparatus does not send indication information of the SL TCI identifier, the second terminal apparatus determines the SL TCI identifier, the signaling overheads of indicating the TCI can further be reduced.

In at least one embodiment, the first signal is a sidelink synchronization signal block, the sidelink synchronization signal block includes a physical sidelink broadcast channel demodulation reference signal, and an initialization parameter of a sequence of the physical sidelink broadcast channel demodulation reference signal is determined based on the first SL TCI identifier.

In at least one embodiment, the initialization parameter of the sequence of the physical sidelink broadcast channel demodulation reference signal satisfies:

$${\text{c}}_{\text{init}} = {2}^{11} \left({\overline{\text{i}}}_{\text{S-SSB}} + 1\right) \left({\text{N}}_{\text{SL}}^{\text{ID}} + 1\right) + {2}^{6} \left({\overline{\text{i}}}_{\text{S-SSB}} + 1\right) + {\text{n}}^{\text{SL} - \text{TCI}}$$

cᵢₙᵢₜ represents the initialization parameter of the sequence of the physical sidelink broadcast channel demodulation reference signal, i̅_{S-SSB} represents an integer value obtained based on an index of the sidelink synchronization signal block,

$${N}_{\text{SL}}^{\text{ID}}$$

represents a sidelink synchronization signal identifier, n^{SL-TCI} represents the first SL TCI identifier, and n^{SL-TCI} is a natural number.

Obtaining i̅_{S-SSB} based on the index of the sidelink synchronization signal block satisfies:

$${\overline{\text{i}}}_{\text{S-SSB}} = {i}_{S - S S B} mod {2}^{U} ⋅ {i}_{S - S S B}$$

represents the index of the sidelink synchronization signal block, U is an integer greater than or equal to 0, and mod represents a modulo operation.

In at least one embodiment, the initialization parameter of the sequence of the physical sidelink broadcast channel demodulation reference signal satisfies:

$${\text{c}}_{\text{init}} = {2}^{\text{M}} {\text{N}}_{\text{SL}}^{\text{ID}} + {\text{n}}^{\text{SL} - \text{TCl}}$$

cᵢₙᵢₜ represents the initialization parameter of the sequence of the physical sidelink broadcast channel demodulation reference signal, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

In at least one embodiment, the first signal is a sidelink synchronization signal block, the sidelink synchronization signal block includes a physical sidelink broadcast channel, and an initialization parameter of a scrambling sequence of the physical sidelink broadcast channel is determined based on the first SL TCI identifier.

In at least one embodiment, the initialization parameter of the scrambling sequence of the physical sidelink broadcast channel satisfies:

$${\text{c}}_{\text{init}} = {2}^{\text{M}} {\text{N}}_{\text{SL}}^{\text{ID}} + {\text{n}}^{\text{SL} - \text{TCl}}$$

cᵢₙᵢₜ represents the initialization parameter of the scrambling sequence of the physical sidelink broadcast channel, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

In at least one embodiment, the method further includes: The first terminal apparatus determines N^{SL-TCI} SL TCI identifiers. N^{SL-TCI} is a positive integer greater than or equal to 1, and the first SL TCI identifier belongs to the N^{SL-TCI} SL TCI identifiers.

The first terminal apparatus sends first configuration information to the second terminal apparatus. The first configuration information is for configuring the N^{SL-TCI} SL TCI identifiers for the second terminal apparatus.

According to the foregoing method, the first terminal apparatus determines the N^{SL-TCI} SL TCI identifiers based on a quantity of panels, transmission beams, antennas, or the like. Then, the first terminal apparatus configures the N^{SL-TCI} SL TCI identifiers for the second terminal device. The first terminal device configures different SL TCI identifiers for the terminal device based on different conditions of the first terminal device, so that adaptability is high and the method of indicating the SL TCI identifier is flexible.

In at least one embodiment, that the first terminal apparatus determines N^{SL-TCI} SL TCI identifiers includes: The first terminal apparatus determines the N^{SL-TCI} SL TCI identifiers based on a quantity of panels, transmission beams, or antennas of a first terminal apparatus.

In at least one embodiment, the first configuration information is carried in a radio resource control message of a PC5 interface, or the first configuration information is carried in a media access control (MAC) control element of a PC5 interface.

In at least one embodiment, the method further includes: The first terminal apparatus determines N^{SL-TCI} SL TCI identifiers based on configuration information of a sending resource pool. N^{SL-TCI} is a positive integer greater than or equal to 1, and the first SL TCI identifier belongs to the N^{SL-TCI} SL TCI identifiers.

According to the foregoing method, the first terminal apparatus and the second terminal device separately determines the N^{SL-TCI} SL TCI identifiers based on configuration information of a sending resource. Configuration is not performed by using additional signaling, so that signaling overheads are reduced.

According to a fourth aspect, a communication method is provided. The communication method is performed by a second terminal apparatus, and includes: The second terminal apparatus receives a first signal from a first terminal apparatus on a first channel; and determines a first sidelink transmission configuration indication SL TCI identifier based on the first signal. The first SL TCI identifier indicates a channel feature of the first channel for transmitting the first signal.

In at least one embodiment, the first signal is a sidelink synchronization signal block, the sidelink synchronization signal block includes a physical sidelink broadcast channel demodulation reference signal, and that the second terminal apparatus determines a first SL TCI identifier based on the first signal includes:

determining the first SL TCI identifier based on an initialization parameter of a sequence of the physical sidelink broadcast channel demodulation reference signal.

In at least one embodiment, the initialization parameter of the sequence of the physical sidelink broadcast channel demodulation reference signal satisfies:

$${\text{c}}_{\text{init}} = {2}^{11} \left({\overline{\text{i}}}_{\text{S} - \text{SSB}} + 1\right) \left({\text{N}}_{\text{SL}}^{\text{ID}} + 1\right) + {2}^{6} \left({\overline{\text{i}}}_{\text{S-SSB}} + 1\right) + {\text{n}}^{\text{SL} - \text{TCl}}$$

cᵢₙᵢₜ represents the initialization parameter of the sequence of the physical sidelink broadcast channel demodulation reference signal, i_{S-SSB} represents an integer value obtained based on an index of the sidelink synchronization signal block,

$${N}_{\text{SL}}^{\text{ID}}$$

represents a sidelink synchronization signal identifier, n^{SL-TCI} represents the first SL TCI identifier, and n^{SL-TCI} is a natural number.

Obtaining i_{S-SSB} based on the index of the sidelink synchronization signal block satisfies:

$${\overline{\text{i}}}_{\text{S-SSB}} = {i}_{S - S S B} mod {2}^{U} ⋅ {i}_{S - S S B}$$

represents the index of the sidelink synchronization signal block, U is an integer greater than or equal to 0, and mod represents a modulo operation.

In at least one embodiment, the initialization parameter of the sequence of the physical sidelink broadcast channel demodulation reference signal satisfies:

$${\text{c}}_{\text{init}} = {2}^{\text{M}} {\text{N}}_{\text{SL}}^{\text{ID}} + {\text{n}}^{\text{SL} - \text{TCI}}$$

cᵢₙᵢₜ represents the initialization parameter of the sequence of the physical sidelink broadcast channel demodulation reference signal, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

In at least one embodiment, the first signal is a sidelink synchronization signal block, the sidelink synchronization signal block includes a physical sidelink broadcast channel, and that the second terminal apparatus determines a first SL TCI identifier based on the first signal includes:

determining the first SL TCI identifier based on an initialization parameter of a scrambling sequence of the physical sidelink broadcast channel.

In at least one embodiment, the initialization parameter of the scrambling sequence of the physical sidelink broadcast channel satisfies:

$${\text{c}}_{\text{init}} = {2}^{\text{M}} {\text{N}}_{\text{SL}}^{\text{ID}} + {\text{n}}^{\text{SL} - \text{TCI}}$$

cᵢₙᵢₜ represents the initialization parameter of the scrambling sequence of the physical sidelink broadcast channel, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

In at least one embodiment, the method further includes: The second terminal apparatus receives first configuration information from the first terminal apparatus. The first configuration information is for configuring N^{SL-TCI} SL TCI identifiers for the second terminal apparatus, and the first SL TCI identifier belongs to the N^{SL-TCI} SL TCI identifiers.

In at least one embodiment, the first configuration information is carried in a radio resource control message of a PC5 interface, or the first configuration information is carried in a media access control (MAC) control element of a PC5 interface.

In at least one embodiment, the method further includes: The second terminal apparatus determines N^{SL-TCI} SL TCI identifiers based on a configuration of a receiving resource pool. N^{SL-TCI} is a positive integer greater than or equal to 1, and the first SL TCI identifier belongs to the N^{SL-TCI} SL TCI identifiers.

According to a fifth aspect, an apparatus is provided. For a beneficial effect, refer to the descriptions of the first aspect. The communication apparatus has a function of implementing behavior in the method embodiment in the first aspect. The function is implemented by executing corresponding hardware or software. The hardware or the software includes one or more units corresponding to the foregoing function.

According to a sixth aspect, an apparatus is provided. For a beneficial effect, refer to the descriptions of the second aspect. The communication apparatus has a function of implementing behavior in the method embodiment in the second aspect. The function is implemented by executing corresponding hardware or software. The hardware or the software includes one or more units corresponding to the foregoing function.

According to a seventh aspect, an apparatus is provided. For a beneficial effect, refer to the descriptions of the third aspect. The communication apparatus has a function of implementing behavior in the method embodiment in the first aspect. The function is implemented by executing corresponding hardware or software. The hardware or the software includes one or more units corresponding to the foregoing function.

According to an eighth aspect, an apparatus is provided. For a beneficial effect, refer to the descriptions of the fourth aspect. The communication apparatus has a function of implementing behavior in the method embodiment in the second aspect. The function is implemented by executing corresponding hardware or software. The hardware or the software includes one or more units corresponding to the foregoing function.

According to a ninth aspect, an apparatus is provided. The apparatus is the terminal device in the foregoing method embodiments, or is a chip disposed in the terminal device. The apparatus includes a communication interface and a processor. Optionally, the communication apparatus further includes a memory. The memory is configured to store a computer program or instructions. The processor is coupled to the memory and the communication interface. In response to the processor executing the computer program or the instructions, the communication apparatus is enabled to perform the method performed by the first terminal device or the second terminal device in the foregoing aspects.

According to a tenth aspect, a computer program product is provided. The computer program product includes computer program code. In response to the computer program code being run, the method performed by the first terminal device or the second terminal device in the foregoing aspects is performed.

According to an eleventh aspect, at least one embodiment provides a chip system. The chip system includes a processor, configured to implement the functions of the first terminal device or the second terminal device in the method in the foregoing aspects. In at least one embodiment, the chip system further includes a memory, configured to store program instructions and/or data. The chip system includes a chip, or includes a chip and another discrete component.

According to a twelfth aspect, at least one embodiment provides a computer-readable storage medium. The computer-readable storage medium stores a computer program. In response to the computer program being run, the method performed by the first terminal device or the second terminal device in the foregoing aspects is implemented.

### BRIEF DESCRIPTION OF DRAWINGS

FIG. 1 is a schematic diagram of a basic architecture of a multi-TRP technology according to at least one embodiment;

FIG. 2 is a schematic diagram of multiple-panel according to at least one embodiment;

FIG. 3 is a schematic diagram of a multiple-beam technology according to at least one embodiment;

FIG. 4 is a schematic diagram of a QCL relationship according to at least one embodiment;

FIG. 5 is a schematic diagram of a network architecture according to at least one embodiment;

FIG. 6 is a schematic diagram of an application scenario according to at least one embodiment;

FIG. 7 is a schematic flowchart of a communication method according to at least one embodiment;

FIG. 8 is a schematic flowchart of a communication method according to at least one embodiment;

FIG. 9 is a schematic flowchart of a communication method according to at least one embodiment;

FIG. 10 is a schematic flowchart of panel selection according to at least one embodiment;

FIG. 11 is a schematic flowchart of panel selection according to at least one embodiment;

FIG. 12 is a schematic flowchart of a communication method according to at least one embodiment;

FIG. 13 is a schematic flowchart of panel selection according to at least one embodiment;

FIG. 14 is a schematic diagram of a structure of an apparatus according to at least one embodiment; and

FIG. 15 is a schematic diagram of a structure of an apparatus according to at least one embodiment.

### DESCRIPTION OF EMBODIMENTS

The following explains and describes some communication nouns or terms used in the embodiments described herein. The communication nouns or terms are also used as a part of content described herein.

### 1. Terminal Apparatus

The terminal apparatus is referred to as a terminal for short, and is a device having a wireless transceiver function. The terminal apparatus is deployed on land, where the deployment includes indoor or outdoor, or handheld or vehicle-mounted deployment, is deployed on water (for example, on a ship), or is deployed in air (for example, on aircraft, a balloon, or a satellite). The terminal apparatus is a mobile phone (mobile phone), a tablet computer (pad), a computer having a wireless transceiver function, a virtual reality (virtual reality, VR) terminal device, an augmented reality (augmented reality, AR) terminal device, a wireless terminal device in industrial control (industrial control), a wireless terminal device in self driving (self driving), a wireless terminal device in telemedicine (telemedicine), a wireless terminal device in a smart grid (smart grid), a wireless terminal device in transportation safety (transportation safety), a wireless terminal device in a smart city (smart city), or a wireless terminal device in a smart home (smart home), or alternatively includes user equipment (user equipment, UE) or the like. Alternatively, the terminal apparatus is a cellular phone, a cordless phone, a session initiation protocol (session initiation protocol, SIP) phone, a wireless local loop (wireless local loop, WLL) station, a personal digital assistant (personal digital assistant, PDA), a handheld device having a wireless communication function, a computing device or another processing device connected to a wireless modem, a vehicle-mounted device, a wearable device, a terminal device in a future 5th generation (5th generation, 5G) network, a terminal device in a future evolved public land mobile network (public land mobile network, PLMN), or the like. The terminal apparatus sometimes is also referred to as a terminal, an access terminal device, a vehicle-mounted terminal device, an industrial control terminal device, a UE unit, a UE station, a mobile station, a mobile console, a remote station, a remote terminal device, a mobile device, a UE terminal device, a terminal device, a wireless communication device, a UE agent, a UE apparatus, or the like. The terminal apparatus alternatively is fixed or mobile. This is not limited in embodiments described herein.

In at least one embodiment, an apparatus configured to implement a function of the terminal is a terminal, or is an apparatus, for example, a chip system, that supports the terminal in implementing this function. The apparatus is mounted in the terminal. In at least one embodiment, the chip system includes a chip, or includes a chip and another discrete component. In the technical solutions provided in embodiments described herein, the technical solutions provided in at least one embodiment are described by using an example in which the apparatus for implementing the terminal function is a terminal and the terminal is UE.

### 2. Sidelink (Sidelink, SL)

The sidelink is also referred to as a sidelink, a sidelink, or the like. A communication interface of the sidelink is referred to as a PC5 interface. The sidelink is used for communication between terminal apparatuses, and includes a physical sidelink shared channel (physical sidelink shared channel, PSSCH) and a physical sidelink control channel (physical sidelink control channel, PSCCH). The PSSCH carries sidelink data (SL data), the PSCCH carries sidelink control information (sidelink control information, SCI), and the SCI is also referred to as a sidelink scheduling assignment (sidelink scheduling assignment, SL SA). The SL SA is information related to data scheduling. For example, the SL SA includes information such as resource allocation and/or a modulation and coding scheme (modulation and coding scheme, MCS) of the PSSCH. Optionally, sidelink communication further includes a physical sidelink feedback channel (physical sidelink feedback channel, PSFCH). The physical sidelink feedback channel is also referred to as a sidelink feedback channel for short. The sidelink feedback channel is for transmitting sidelink feedback control information (sidelink feedback control information, SFCI), and the sidelink feedback control information includes at least one of channel state information (channel state information, CSI), hybrid automatic repeat request (hybrid automatic repeat request, HARQ) information, and the like. The HARQ information includes acknowledgement information (acknowledgement, ACK), a negative acknowledgement (negative acknowledgement, NACK), or the like.

### 3. Uu Air Interface

The Uu air interface is understood as a universal interface (universal UE to network interface) between a terminal apparatus and a network device, and the Uu air interface is used for communication between the terminal apparatus and the network apparatus. Transmission over the Uu air interface includes uplink transmission and downlink transmission.

The uplink transmission means that the terminal apparatus sends information to the network apparatus, and the information in the uplink transmission is referred to as uplink information or an uplink signal. The uplink information or the uplink signal may include one or more of an uplink data signal, an uplink control signal, and a sounding reference signal (sounding reference signal, SRS). A channel for transmitting the uplink information or the uplink signal is referred to as an uplink channel, and the uplink channel includes one or more of a physical uplink data channel (physical uplink shared channel, PUSCH) and a physical uplink control channel (physical uplink control channel, PUCCH). The PUSCH carries uplink data, and the uplink data is also referred to as uplink data information. The PUCCH carries uplink control information (uplink control information, UCI) fed back by the terminal apparatus. For example, the UCI includes one or more of channel state information (channel state information, CSI), an ACK, a NACK, and the like that are fed back by the terminal apparatus.

The downlink transmission means that the network apparatus sends information to the terminal apparatus, and the information in the downlink transmission is downlink information or a downlink signal. The downlink information or the downlink signal includes one or more of a downlink data signal, a downlink control signal, a channel state information reference signal (channel state information reference signal, CSI-RS), and a phase-tracking reference signal (phase-tracking reference signal, PTRS). A channel for transmitting the downlink information or the downlink signal is referred to as a downlink channel, and the downlink channel includes one or more of a physical downlink data channel (physical downlink shared channel, PDSCH) and a physical downlink control channel (physical downlink control channel, PDCCH). The PDCCH carries downlink control information (downlink control information, DCI), and the PDSCH carries downlink data (data). The downlink data is also referred to as downlink data information.

### 4. SL CSI-RS Pattern

The SL CSI-RS pattern in at least one embodiment is similar to a CSI-RS resource in a Uu air interface. One SL CSI-RS pattern corresponds to one SL CSI-RS configuration. A configuration parameter is a quantity of ports, a frequency domain position, a time domain position, or the like. This is not limited.

In at least one embodiment, one or more SL CSI-RS patterns is configured for a first terminal apparatus and a second terminal device. SL CSI-RSs sent by different panels, transmission beams, or antennas corresponds to a same pattern or different patterns.

### 5. Beam

The beam is embodied as a spatial domain filter (spatial domain filter) in a protocol, or referred to as a spatial filter (spatial filter), a spatial parameter (spatial parameter), or the like. A beam used to send a signal is referred to as a transmission beam (transmission beam, Tx beam), a spatial domain transmission filter (spatial domain transmission filter), a spatial transmission parameter (spatial transmission parameter), or the like. A beam used to receive a signal is referred to as a reception beam (reception beam, Rx beam), a spatial domain receive filter (spatial domain receive filter), a spatial reception parameter (spatial RX parameter), or the like.

The transmission beam refers to distribution of signal strength formed in different directions in space after a signal is transmitted through an antenna, and the reception beam refers to distribution of signal strength, in different directions in space, of a radio signal received from an antenna.

In addition, the beam is a wide beam, a narrow beam, a beam of another type, or the like. A technology for forming the beam is a beamforming technology or another technology. This is not limited. For example, the beamforming technology is specifically a digital beamforming technology, an analog beamforming technology, or a hybrid digital/analog beamforming technology.

Optionally, a plurality of beams having a same communication feature or similar communication features is considered as one beam. One beam includes one or more antenna ports, configured to transmit a data channel, a control channel, a sounding signal, and the like. The one or more antenna ports forming the beam is also considered as one antenna port set.

The beam usually corresponds to a resource. For example, in response to beam measurement being performed, a transmitting end measures different beams by using different resources, and a receiving end feeds back measured resource quality, so that the transmitting end determines quality of a corresponding beam. In at least one embodiment, unless otherwise specified, the beam is a transmission beam of the transmitting end. During beam measurement, a beam corresponds to one resource. Therefore, an index of the resource is used to uniquely identify a beam corresponding to the resource.

In at least one embodiment, “/” indicates an “or” relationship between associated objects unless otherwise specified. For example, A/B may represent A or B. The term “and/or” in at least one embodiment is merely an association relationship for describing associated objects, and represents that three relationships exist. For example, A and/or B represent the following three cases: Only A exists, both A and B exist, and only B exists, where A and B each is singular or plural. In addition, in at least one embodiment, “a plurality of” means two or more than two unless otherwise specified. At least one of the following items (pieces) or a similar expression thereof refers to any combination of these items, including any combination of singular items (pieces) or plural items (pieces). For example, at least one item (piece) of a, b, or c indicates: a, b, c, a and b, a and c, b and c, or a, b, and c, where a, b, and c is singular or plural. In addition, to clearly describe the technical solutions in at least one embodiment, terms such as first and second are used in at least one embodiment to distinguish between same items or similar items that provide basically same functions or purposes. A person skilled in the art understands that the terms such as “first” and “second” do not limit a quantity or an execution sequence, and the terms such as “first” and “second” do not indicate a difference.

In addition, the network architecture and the service scenario described in at least one embodiment are intended to describe the technical solutions in at least one embodiment more clearly, and do not constitute a limitation on the technical solutions provided in at least one embodiment. A person of ordinary skill in the art knows that: With the evolution of the network architecture and the emergence of new service scenarios, the technical solutions provided in at least one embodiment are also applicable to similar technical problems.

In the past few decades, a wireless communication system has undergone technical evolution from first-generation analog communication to fifth-generation new radio (new radio, NR). With the evolution, resources used in the wireless communication system gradually develop from two dimensions, namely, time domain and frequency domain, to three dimensions, namely, time domain, frequency domain, and space domain. Use of a space domain resource stems from development of a multiple-input multiple-output (multiple-input multiple-output, MIMO) system. In the MIMO system, a transmitting end sends data by using a plurality of antennas, and a receiving end also receives data by using a plurality of antennas, to implement parallel transmission of a plurality of spatial data flows between the transmitting end and the receiving end, so as to improve a communication speed and communication reliability. With further evolution of the MIMO technology, technologies such as multiple-transmission and reception point (multiple-transmission and reception point, Multi-TRP), multiple-panel (multiple-panel, Multi-panel), and multiple-beam (multiple-beam, Multi-beam) are proposed in a Uu air interface of NR, and are areas for direction of technical development.

A basic architecture of the multi-TRP technology is shown in FIG. 1. A plurality of transmission reception points (transmission reception points, TRPs) simultaneously transmits data to one terminal apparatus (for example, UE), to improve a communication rate and reliability. At least one embodiment of the TRP is a 5G base station.

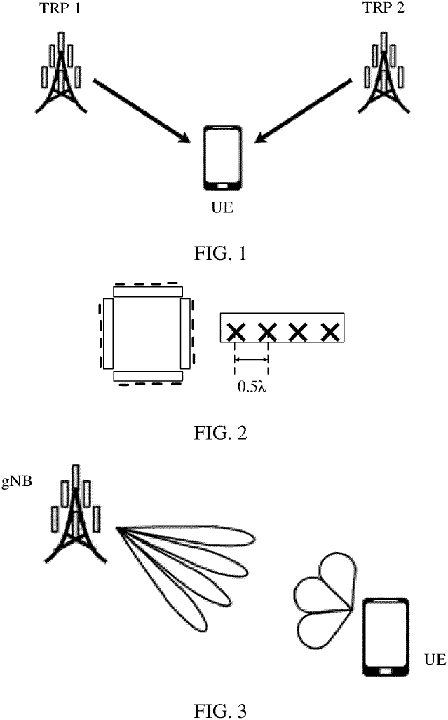

The multiple-panel technology enables a plurality of panels (panels) to exist on a terminal apparatus side and a network apparatus side, and one or more antennas are mounted on a panel. On the network apparatus side, use of the plurality of panels avoids an overhead problem and a power consumption problem during deployment of a massive MIMO system. On the terminal device side, because the panel is generally directional, more spatial directions is covered by using the plurality of panels, so that communication reliability is improved. As shown in FIG. 2, a top view of four panels is on the left side, and a horizontal view of a panel is on the right side. As shown on the right side of FIG. 2, four dual-polarized antennas is mounted on the panel, and a horizontal distance between every two dual-polarized antennas is 0.5 λ. λ represents a wavelength of a signal. In response to a terminal apparatus using four panels, the terminal apparatus sends data in different directions, or receives data from different directions.

The multiple-beam technology is generally applied to a high frequency band above 20 GHz. A beamforming (beamforming) technology enables a network apparatus, a terminal apparatus, and the like to form beams (beams) in one or more spatial directions, so that a communication rate and reliability are improved through sending and receiving in the directions. As shown in FIG. 3, a network apparatus transmits data to a terminal apparatus by using transmission beams in different directions, and the terminal apparatus receives data by using reception beams in different directions.

In response to the foregoing MIMO technology being used, a receiving end is capable of distinguishing between signals sent by different TRPs, panels, or beams. Therefore, two concepts are used in NR: quasi co-located (quasi co-located, QCL) and a transmission configuration indication (transmission configuration indication, TCI).

Before a definition of the QCL is provided, an antenna port (antenna port) is first explained. The antenna port is a logical concept widely used in the 3rd generation partnership project (3rd generation partnership project, 3GPP), and is defined as follows: A channel feature experienced by a signal on an antenna port is derived from a channel feature experienced by another signal transmitted on the same antenna port. The antenna port is different from an actually used physical antenna. A plurality of physical antennas corresponds to a same antenna port, and one physical antenna alternatively corresponds to a plurality of antenna ports.

Based on the antenna port, the QCL is defined as follows: A channel feature experienced by a signal on an antenna port is derived from a channel feature experienced by a signal on another antenna port, and the two antenna ports are QCL. In addition, there is also a QCL relationship between reference signals (reference signals, RSs) transmitted on the two antenna ports. For example, in response to an antenna port 1 and an antenna port 2 being QCL, the antenna port 1 is for transmitting a first RS, and the antenna port 2 is for transmitting a second RS, there is also a QCL relationship between the first RS and the second RS.

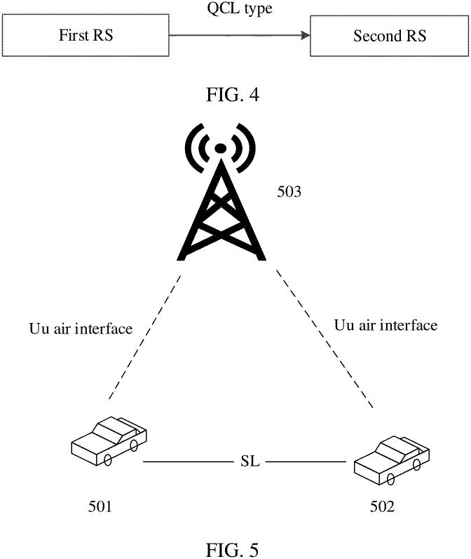

In NR, a TCI is used to indicate a QCL relationship between two RSs. The two RSs are respectively a first RS and a second RS. A network apparatus configures a TCI-state (TCI-state) for the first RS by using radio resource control (radio resource control, RRC) signaling. As shown in FIG. 4, a terminal apparatus determines, by using a TCI-state, a second RS that has a QCL relationship with a first RS based on a QCL type. Then, the terminal apparatus derives a channel feature of the first RS by using a channel feature of the second RS, to better receive the first RS. Optionally, the second RS is a channel state information reference signal (channel state information reference signal, CSI-RS), a synchronization signal block (synchronization signal block, SSB), or the like.

In an NR system, in addition to the Uu air interface, there is a PC5 interface. The PC5 interface is a communication interface between terminal apparatuses. A transmission link in the PC5 interface is a sidelink. However, currently, there is still a lack of a method of configuring and indicating an SL TCI identifier in the standard. This hinders use of the MIMO technologies such as the multiple-panel and the multiple-beam in the PC5 interface.

In the following descriptions, an example in which a network apparatus is a gNB and a terminal apparatus is UE is used to describe in detail a method of configuring and indicating a TCI in a Uu air interface, and a problem existing in response to the method of configuring and indicating the TCI in the Uu air interface being directly applied to a PC5 interface.

In the Uu air interface, the gNB configures a plurality of TCI-states for the UE by using RRC signaling, and then indicate a TCI-state of an RS by using a media access control (media access control, MAC) control element (control element, CE) or downlink control information (downlink control information, DCI).

In the Uu air interface, an information element (information element, IE) of the TCI-state that is configured by using the RRC signaling includes at least one of the following information elements:

1. TCI-state identifier (tci-StateId): The TCI-state identifier provides an identifier (identification, ID) of the TCI-state.

2. Type-1 qcl (qcl-Type1): The type-1 qcl provides a QCL relationship and a corresponding RS, where the qcl-Type1 continues to point to a QCL-Info information element, and the QCL-Info information element provides a specific parameter of the QCL type.

3. Type-2 qcl (qcl-Type2): The type-2 qcl provides another QCL relationship and a corresponding RS, where the qcl-Type2 continues to point to a QCL-Info information element, and the QCL-Info information element provides a specific parameter of the QCL type.

The QCL-Info information element further includes the following two information elements, which are explained as follows:

1. Reference signal (referenceSignal): The reference signal provides an RS corresponding to a QCL relationship, where the RS is a CSI-RS resource with an ID, or an SSB with a number (index). A CSI-RS is represented as a CSI-RS resource, one CSI-RS resource corresponds to one CSI-RS configuration, a CSI-RS configuration parameter includes parameters such as a resource ID and a resource mapping, and the resource mapping parameter further includes a quantity of ports, a frequency domain position, a time domain position, and the like.

2. qcl-type (qcl-Type): The qcl-type provides a QCL type corresponding to a QCL relationship, where the QCL type is any one of {type A, type B, type C, type D}.

A QCL type corresponds to a combination of one or more channel features, and a channel feature includes a Doppler frequency shift, a Doppler spread, an average delay, a delay spread, a spatial reception parameter, and the like. A channel feature combination corresponding to a QCL type is briefly described as follows: a type A: {Doppler shift, Doppler spread, average delay, delay spread}; a type B: {Doppler shift, Doppler spread}; a type C: {Doppler shift, average delay}; and a type D: {spatial reception parameter}.

In response to there being a QCL relationship between two antenna ports based on a QCL type, channel features experienced by signals on the two antenna ports are the same as a channel feature corresponding to the QCL type. The type D is used as an example. The QCL type corresponds to a spatial reception parameter. Therefore, in response to there being a QCL relationship between two antenna ports based on the type D, channels experienced by signals on the two antenna ports have a same spatial reception parameter.

Four QCL types are considered in the Uu air interface, so that the UE determines QCL types of RSs at a plurality of transmitting ends in a scenario of a plurality of sending devices such as an inter-gNodeB handover and multi-TRP. However, for SL scenarios such as vehicle-to-everything V2X communication and device-to-device D2D communication, a scenario of a plurality of transmitting end UEs is simply decomposed into a plurality of unicast (unicast) links including transmitting end UE and receiving end UE. A unicast link is distinguished by using IDs of the transmitting end UE and the receiving end UE. Therefore, in the SL scenario, a QCL relationship between RSs on the unicast link is involved. Therefore, a TCI definition is simplified in the PC5 interface, to reduce signaling overheads of configuring and indicating the TCI-state.

Based on the foregoing descriptions, an SL TCI identifier is redefined in at least one embodiment, and the SL TCI identifier is defined as an identifier (ID) of a channel feature experienced by a signal on an antenna port on an SL. UE considers that signals with the same SL TCI identifier experience the same channel feature. Optionally, the channel feature is a spatial reception parameter. In other words, one QCL type, namely, the type D (type D) in the Uu air interface is considered for the SL TCI identifier. For example, in response to an SL TCI identifier of a PSSCH demodulation reference signal (demodulation reference signal, DMRS) being 0, and an SL TCI identifier of a sidelink channel state information reference signal (sidelink channel state information reference signal, SL CSI-RS) is also 0, the UE considers that spatial reception parameters experienced by the PSSCH DMRS and the SL CSI-RS are the same. In response to the spatial reception parameters being the same, the PSSCH DMRS and the SL CSI-RS are sent by using a same panel or beam. The name of the SL TCI identifier is also replaced with a QCL identifier (QCL ID), a QCL number (QCL index), or the like. This is not limited.

In at least one embodiment, the definition of the SL TCI identifier is simplified, so that signaling overheads used to configure and indicate the TCI are reduced compared with those in the Uu air interface. Therefore, a technical problem that a configuration and indication method is excessively complex because there are excessively many QCL types in the Uu air interface is resolved.

Optionally, a value range of any SL TCI identifier in at least one embodiment is an integer value in

$$\left\{0 , 1 , 2 , … , {\text{N}}_{\text{max}}^{\text{SL} - \text{TCI}} - 1\right\} ,$$

where

$${\text{N}}_{\text{max}}^{\text{SL} - \text{TCI}}$$

is a positive integer greater than or equal to 1, and indicates a maximum quantity of the SL TCI identifier. Optionally,

$${\text{N}}_{\text{max}}^{\text{SL} - \text{TCI}}$$

is one of {8, 16, 32, 64, 128}. The TCI in the Uu air interface is represented as a TCI-state, and the TCI-state provides an identifier of the TCI-state, and an RS and a QCL type that correspond to a QCL relationship. In at least one embodiment, the TCI in the PC5 interface is represented as a TCI identifier, and a QCL relationship is not provided. In this way, a design is simplified and signaling overheads are reduced.

In addition, in the Uu interface, signaling used to implement configuration and indication of the TCI-state of the RS includes signaling such as RRC, a MAC CE, and DCI. This is excessively complex for configuring and indicating the TCI in the SL scenario. In addition, there is no RRC signaling in the PC5 interface, and there is PC5-RRC signaling. In addition, the PC5-RRC signaling in the SL does not include a similar information element similar to the TCI-state configured in the Uu air interface. The MAC CE in the PC5 interface does not include the MAC CE that activates a plurality of TCI-states in the Uu air interface. Therefore, in the PC5 interface, the TCI cannot be configured and indicated according to the method in the Uu air interface.

Based on the foregoing descriptions, at least one embodiment provides a communication method and an apparatus, to resolve a technical problem that a current SL lacks a configuration and an indication of an SL TCI identifier. There are two solutions for indicating the SL TCI identifier. A first solution is an explicit indication. A first terminal apparatus sends first indication information to a second terminal apparatus, where the first indication information indicates an SL TCI identifier of a first reference signal. The second terminal apparatus determines the SL TCI identifier of the first reference signal based on the first indication information. A second solution is an implicit indication. A first terminal apparatus generates a first signal based on an SL TCI identifier of the first signal, and send the first signal to a second terminal apparatus. Then, the second terminal apparatus determines the SL TCI identifier of the first signal based on the first signal. There are two solutions for configuring the SL TCI identifier. In a first solution, a first terminal apparatus determines a plurality of SL TCI identifiers based on a quantity of panels, transmission beams, or antennas. Then, the first terminal apparatus sends configuration information of the plurality of SL TCI identifiers to a second terminal apparatus. In a second solution, a plurality of SL TCI identifiers are preconfigured in a resource pool. A first terminal apparatus and a second terminal apparatus determine the plurality of SL TCI identifiers based on configuration information of the corresponding resource pool.

A communication method and an apparatus provided in at least one embodiment is applied to a network architecture. As shown in FIG. 5, a network architecture is provided, including a first terminal apparatus 501 and a second terminal apparatus 502. Sidelink communication is performed between the first terminal apparatus 501 and the second terminal apparatus 502 over a sidelink, to transmit sidelink information. The transmitted sidelink information includes data (data), a scheduling assignment (scheduling assignment, SA), and the like. Optionally, the sidelink information further includes channel state information (channel state information, CSI), hybrid automatic repeat request (hybrid automatic repeat request, HARQ) information, and the like. The HARQ information is specifically acknowledgement information (acknowledgement, ACK), a negative acknowledgement (negative acknowledgement, NACK), or the like.

Optionally, the network architecture shown in FIG. 5 further includes a network apparatus 503, and the network apparatus 503 is an access network device. The terminal apparatus 501 and/or the terminal apparatus 502 communicates with the network apparatus 503 through a Uu air interface. Communication in the Uu air interface includes uplink transmission and downlink transmission. The uplink transmission means that the terminal apparatus 501 and/or the terminal device 502 send/sends an uplink signal or uplink information to the network apparatus 503. The downlink transmission means that the network apparatus 503 sends a downlink signal or downlink information to the terminal apparatus 501 and/or the terminal apparatus 502.

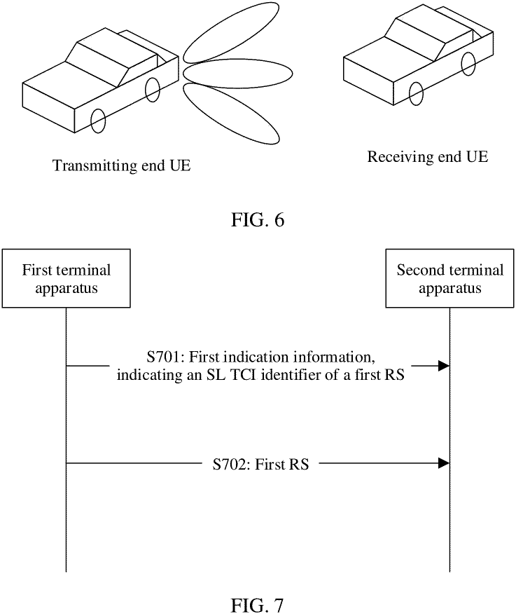

The communication method and the apparatus provided in at least one embodiment is applied to an SL scenario. The SL scenario includes a scenario such as vehicle-to-everything (vehicle-to-everything, V2X) or device-to-device (device-to-device, D2D). As shown in FIG. 6, a vehicle-to-vehicle (vehicle-to-vehicle, V2V) scenario is used as an example. Transmitting end UE and receiving end UE is respectively described as a first terminal apparatus and a second terminal apparatus. In FIG. 6, for example, the transmitting end UE and the receiving end UE are vehicle UE. The transmitting end UE and the receiving end UE in an actual application scenario is terminal devices in any form. The foregoing scenario further includes a transmission beam. The transmission beam is a directional radiation mode formed by the transmitting end UE by using a sending signal and by using a technology such as multiple-panel or multiple-beam, and is represented by a water drop shape in FIG. 6.

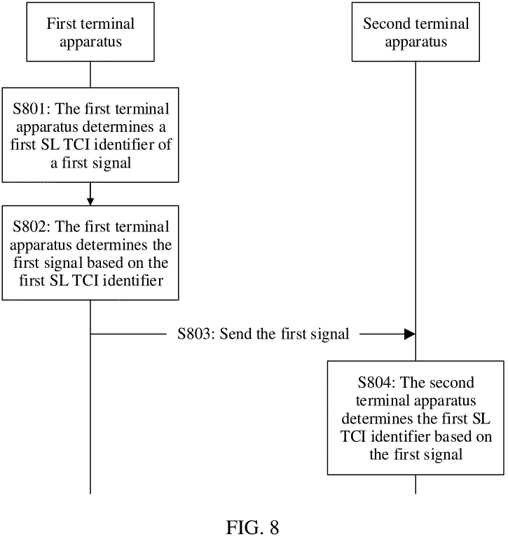

As shown in FIG. 7, a communication method is provided. The communication method corresponds to the foregoing first explicit indication solution, and the method is performed by a first terminal apparatus and a second terminal apparatus. The first terminal apparatus and the second terminal apparatus is terminal devices, or components (for example, chips, circuits, or other components) located in the terminal devices. The procedure includes the following steps.

S701: The first terminal apparatus sends first indication information to the second terminal apparatus. Correspondingly, the second terminal device receives the first indication information from the first terminal device.

S702: The first terminal apparatus sends a first RS to the second terminal apparatus on a first channel. Correspondingly, the second terminal apparatus receives the first RS from the first terminal device on the first channel. The first indication information indicates a first SL TCI identifier of the first RS. The first SL TCI identifier indicates a channel feature of the first channel for transmitting the first RS, or the first SL TCI identifier indicates a channel feature experienced by the first RS. Because the first terminal apparatus sends the first RS by using different panels, transmission beams, or antennas, channel features experienced by the first RS are different. Therefore, the SL TCI identifier is used to identify the different panels, transmission beams, antennas, or the like. In at least one embodiment, after receiving the first indication information, the second terminal device determines the SL TCI identifier of the first RS based on the first indication information. Further, the second terminal device determines, based on the SL TCI identifier of the first RS, the panel, the transmission beam, the antenna, or the like used by the first terminal device to send the first RS. The first terminal apparatus simultaneously performs S701 and S702. To be specific, the first terminal apparatus simultaneously sends the first indication information and the first RS to the second terminal apparatus. Alternatively, the first terminal apparatus sends the first indication information and the first RS in sequence. For example, the first terminal apparatus first sends the first indication information and then send the first RS, or first send the first RS and then send the first indication information. This is not limited.

Optionally, the first reference signal includes a PSSCH DMRS, a physical sidelink control channel (physical sidelink control channel, PSCCH) DMRS, or an SL CSI-RS. The first indication information in S701 is carried in second-stage SCI (2^{nd} stage SCI).

SCI in a sidelink includes first-stage SCI (1^{st} stage SCI) and the second-stage SCI. The first-stage SCI is carried on a PSCCH, and is mainly for scheduling a corresponding PSSCH and the second-stage SCI. The second-stage SCI is carried on the PSSCH, and is mainly for demodulating and decoding the corresponding PSSCH and/or control HARQ and CSI procedures.

For a method of indicating an SL TCI identifier of the PSSCH DMRS and/or the PSCCH DMRS, in at least one embodiment, the first terminal apparatus sends first indication information to the second terminal apparatus. The first indication information indicates the SL TCI identifier of the PSSCH DMRS and/or the PSCCH DMRS, and the first indication information is carried in M bits in the second-stage SCI, where M is a positive integer. The second terminal apparatus determines the SL TCI identifier of the PSSCH DMRS and/or the PSCCH DMRS based on the first indication information. Optionally, M is a positive integer defined in a standard. For example, M is one of {1, 2, 3, 4, 5, 6}. Alternatively, M is a positive integer obtained based on a configured quantity N^{SL-TCI} of SL TCI identifiers. For example, M may satisfy: M = [log₂ (N^{SL-TCI})].

For a method of indicating an SL TCI identifier of the SL CSI-RS, in at least one embodiment, the first terminal apparatus configures an SL CSI-RS pattern (pattern), and send first indication information to the second terminal apparatus. The first indication information indicates the SL TCI identifier of an SL CSI-RS. The first indication information is carried in M bits in the second-stage SCI, where M is a positive integer. Receiving end UE determines the SL TCI identifier of the SL CSI-RS based on the first indication information. Similarly, M is a positive integer defined in a standard. For example, M is one of {1, 2, 3, 4, 5, 6}. Alternatively, M is a positive integer obtained based on a configured quantity N^{SL-TCI} of SL TCI identifiers. For example, M satisfies: M = [log₂ (N^{SL-TCI})]. Optionally, the first terminal apparatus includes the indication information of the SL TCI identifier in the second-stage SCI in response to the first terminal apparatus triggering channel measurement by using the second-stage SCI. Otherwise, the first terminal apparatus no longer includes the indication information of the SL TCI identifier in the second-stage SCI.

In at least one embodiment, according to the foregoing provided method of indicating the SL TCI identifier, a disadvantage that a current SL lacks a method of indicating an SL TCI identifier is compensated for. Further, based on the foregoing provided simplified definition of the SL TCI identifier, in comparison with the Uu air interface, signaling overheads of indicating the TCI is reduced, to resolve a technical problem that a TCI indication method is excessively complex because there are excessively many QCL types in the Uu air interface.

As shown in FIG. 8, a communication method is provided. The communication method corresponds to the foregoing second implicit indication solution, and the method is performed by a first terminal apparatus and a second terminal apparatus. The first terminal apparatus and the second terminal apparatus is terminal devices, or components (for example, chips, circuits, or other components) located in the terminal devices. The procedure includes the following steps.

S801: The first terminal apparatus determines a first SL TCI identifier of a first signal, where the first SL TCI identifier indicates a channel feature of a first channel for transmitting the first signal, or the first SL TCI identifier is an identifier of a channel feature experienced by a channel for transmitting the first signal.

S802: The first terminal apparatus determines the first signal based on the first SL TCI identifier.

S803: The first terminal apparatus sends the first signal to the second terminal apparatus on the first channel. Correspondingly, the second terminal apparatus receives the first signal from the first terminal apparatus on the first channel.

S804: The second terminal apparatus determines the first SL TCI identifier based on the first signal. Optionally, because the first signal is sent by using different panels, beams, or antennas, channel features experienced by the first signal are different. Therefore, the SL TCI identifier is used to identify the different panels, beams, or antennas. In at least one embodiment, after determining the SL TCI identifier of the first signal, the second terminal device further determines, based on the SL TCI identifier of the first signal, the panel, the beam, the antenna, or the like for sending the first signal.

In at least one embodiment, the first signal is a sidelink synchronization signal block (sidelink synchronization signal block, S-SSB), and the S-SSB includes a physical sidelink broadcast channel (physical sidelink broadcast channel, PSBCH) DMRS. An initialization (initialization) parameter of a sequence of the PSBCH DMRS is generated based on the first SL TCI identifier. A specific implementation of S802 is: The first terminal apparatus generates the initialization parameter of the sequence of the PSBCH DMRS based on the first SL TCI identifier; and the first terminal apparatus generates the sequence of the PSBCH DMRS based on the initialization parameter of the sequence of the PSBCH DMRS. A specific implementation of S804 is: The second terminal apparatus determines the initialization parameter of the sequence of the PSBCH DMRS based on the received PSBCH DMRS; and the second terminal apparatus determines the first SL TCI identifier based on the initialization parameter of the sequence of the PSBCH DMRS.

Optionally, the initialization parameter of the sequence of the PSBCH DMRS satisfies:

$${\text{c}}_{\text{init}} = {2}^{11} \left({\overline{\text{i}}}_{\text{S-SSB}} + 1\right) \left({\text{N}}_{\text{SL}}^{\text{ID}} + 1\right) + {2}^{6} \left({\overline{\text{i}}}_{\text{S-SSB}} + 1\right) + {\text{n}}^{\text{SL} - \text{TCI}}$$

cᵢₙᵢₜ represents the initialization parameter of the sequence of the PSBCH DMRS, i_{S-SSB} represents an integer value obtained based on an S-SSB index (i_{S-SSB}),

$${\text{N}}_{\text{SL}}^{\text{ID}}$$

represents a sidelink synchronization signal identifier (sidelink synchronization signal identification, SL SSID), n^{SL-TCI} represents the first SL TCI identifier, and n^{SL-TCI} is an integer satisfying 0 ≤ n^{SL-TCI} ≤ N^{SL-TCI} – 1. Further, optionally, a process of obtaining the integer value i_{S-SSB} based on the S-SSB index i_{S-SSB} satisfies: i̅_{S-SSB} = i_{S-SSB} mod 2^{U}. mod represents a modulo operation, and U is an integer greater than or equal to 0. For example, U is one of {1, 2, 3, 4}, and preferably U = 3.

Alternatively, the initialization parameter of the sequence of the PSBCH DMRS satisfies:

$${\text{c}}_{\text{init}} = {2}^{\text{M}} {\text{N}}_{\text{SL}}^{\text{ID}} + {\text{n}}^{\text{SL} - \text{TCl}}$$

cᵢₙᵢₜ represents the initialization parameter of the sequence of the PSBCH DMRS,

$${\text{N}}_{\text{SL}}^{\text{ID}}$$

represents an SL SSID, n^{SL-TCI} represents the first SL TCI identifier, n^{SL-TCI} is an integer satisfying 0 ≤n^{SL-TCI} ≤N^{SL-TCI} –1, and M is a positive integer. M is a positive integer defined in a standard. For example, M is one of {1, 2, 3, 4, 5, 6}. Alternatively, M is a positive integer obtained based on a configured quantity N^{SL-TCI} of SL TCI identifiers. For example, M = [log₂ (N^{SL-TCI})].

In at least one embodiment, the first signal is an S-SSB. The S-SSB also includes a PSBCH. An initialization parameter of a scrambling sequence of the PSBCH is determined based on the first SL TCI identifier. A specific implementation of S802 is: The first terminal apparatus determines a scrambling sequence based on an initialization parameter of the scrambling (scrambling) sequence of encoded bits (encoded bits) on the PSBCH; and scrambles the PSBCH by using the scrambling sequence. A specific implementation of S804 is: The second terminal apparatus descrambles the PSBCH, to determine the scrambling sequence of the encoded bits on the PSBCH; determines the initialization parameter of the scrambling sequence of the PSBCH based on the scrambling sequence of the encoded bits on the PSBCH; and further determines the first SL TCI identifier based on the initialization parameter of the scrambling sequence.

Optionally, the initialization parameter of the scrambling sequence of the PSBCH satisfies:

$${\text{c}}_{\text{init}} = {2}^{\text{M}} {\text{N}}_{\text{SL}}^{\text{ID}} + {\text{n}}^{\text{SL} - \text{TCl}}$$

cᵢₙᵢₜ represents the initialization parameter of the scrambling sequence of the PSBCH,

$${N}_{\text{SL}}^{\text{ID}}$$

represents an SL SSID, n^{SL-TCI} represents the first SL TCI identifier, n^{SL-TCI} is an integer satisfying 0 ≤n^{SL-TCI} ≤N^{SL-TCI} – 1, and M is a positive integer. M is a positive integer defined in a standard. For example, M is one of {1, 2, 3, 4, 5, 6}. Alternatively, M is a positive integer obtained based on a configured quantity N^{SL-TCI} of SL TCI identifiers. For example, M = [log₂ (N^{SL-TCI})].

In at least one embodiment, according to the foregoing method of indicating the SL TCI identifier, not only a technical disadvantage of a lack of the SL TCI identifier in an SL is compensated for, but also signaling overheads of indicating the TCI are reduced in comparison with a Uu air interface. Further, in this embodiment, because the first terminal apparatus does not send indication information of the SL TCI identifier, the second terminal apparatus determines the SL TCI identifier, the signaling overheads of indicating the TCI is further reduced.

At least one embodiment further provides a communication method. According to this communication method, an SL TCI identifier is configured for a first terminal apparatus and/or a second terminal apparatus.

In at least one embodiment, the first terminal apparatus determines N^{SL-TCI} SL TCI identifiers, and send first configuration information to the second terminal apparatus, where the first configuration information is for configuring the N^{SL-TCI} SL TCI identifiers for the second terminal apparatus. Optionally, the first configuration information is carried in PC5-RRC signaling or a MAC CE of a PC5 interface. N^{SL-TCI} is a positive integer greater than or equal to 1 and less than or equal to

$${\text{N}}_{\text{max}}^{\text{SL} - \text{TCl}}$$

.The N^{SL-TCI} SL TCI identifiers represent a quantity of SL TCI identifiers that are used by the first terminal apparatus to send an RS.

Optionally, N^{SL-TCI} is obtained based on a quantity of panels activated by the first terminal apparatus or a quantity of the panels. For example, in response to the first terminal apparatus having four panels, the first terminal apparatus configures N^{SL-TCI} = 4 SL TCI identifiers. Further, in response to there being one antenna on a panel, a quantity of panels is equivalent to a quantity of antennas. Alternatively, N^{SL-TCI} is determined based on a quantity of transmission beams supported by the first terminal apparatus. For example, in response to the first terminal apparatus supporting 32 transmission beams, the first terminal apparatus configures N^{SL-TCI} = 32 SL TCI identifiers.

In at least one embodiment, N^{SL-TCI} SL TCI identifiers is configured in a resource pool (resource pool). N^{SL-TCI} is a positive integer greater than or equal to 1 and less than or equal to

$${\text{N}}_{\text{max}}^{\text{SL-TCl}}$$

. The N^{SL-TCI} SL TCI identifiers represents a quantity of SL TCI identifiers that is used by any sending apparatus in the resource pool to send an RS. The resource pool is a set of time-frequency resources that is used for SL transmission, and is in a specific form of a set corresponding to a plurality of orthogonal frequency division multiplexing (orthogonal frequency division multiplexing, OFDM) symbols in time domain and a plurality of consecutive physical resource blocks (physical resource blocks, PRBs) in frequency domain. A PRB includes 12 subcarriers (subcarrier) in frequency domain. The resource pool is specifically a sending resource pool or a receiving resource pool. Correspondingly, the first terminal apparatus determines the N^{SL-TCI} SL-TCI identifiers based on configuration information of the sending resource pool. The second terminal apparatus determines the N^{SL-TCI} SL-TCI identifiers based on configuration information of the receiving resource pool.

In at least one embodiment, according to the foregoing method of configuring the SL TCI identifier, a technical disadvantage of a lack of the SL TCI identifier in an SL is compensated for. In addition, based on the foregoing proposed simplified definition of the SL TCI identifier, in comparison with the Uu air interface, signaling overheads of configuring the TCI is reduced, to resolve a technical problem that a TCI configuration method is excessively complex because there are excessively many QCL types in the Uu air interface.

The method of configuring the SL TCI identifier and the method of indicating the SL TCI identifier is used in combination, or is used independently. This is not limited.

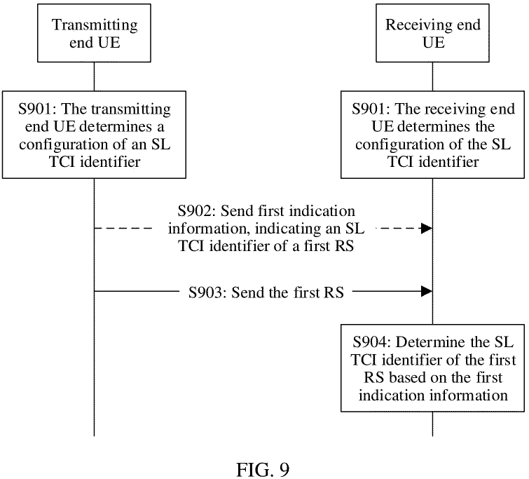

As shown in FIG. 9, a communication method is provided. The communication method is an example in which the method of configuring the SL TCI identifier and the method of indicating the SL TCI identifier are used in combination. In this procedure, an example in which a first terminal apparatus is transmitting end UE and a second terminal apparatus is receiving end UE is used for description. The procedure includes the following steps.

S901: The transmitting end UE determines a configuration of an SL TCI identifier, and the receiving end UE determines the configuration of the SL TCI identifier.

In at least one embodiment, the transmitting end UE configures N^{SL-TCI} SL TCI identifiers, and sends configuration information to the receiving end UE. The configuration information is for configuring the N^{SL-TCI} SL TCI identifiers, the configuration information is carried in PC5-RRC signaling or a MAC CE, and N^{SL-TCI} is a positive integer less than or equal to

$${N}_{m a x}^{S L - T C}$$

. Alternatively, N^{SL-TCI} SL TCI identifiers are configured in a resource pool (resource pool). The transmitting end UE determines the N^{SL-TCI} SL TCI identifiers based on configuration information of the resource pool. The receiving end UE determines the N^{SL-TCI} SL TCI identifiers based on the configuration information of the resource pool.

In at least one embodiment, the transmitting end UE indicates an SL TCI identifier of a first RS in an explicit indication manner or an implicit indication manner. If the transmitting end UE indicates the SL TCI identifier of the first RS in the explicit indication manner, optionally, the procedure shown in FIG. 9 includes S902: The Transmitting end UE sends first indication information to the receiving end UE, where the first indication information indicates the SL TCI identifier of the first RS, and the first RS is any RS sent by the transmitting end UE.

In response to the first RS being a PSSCH DMRS and/or a PSSCH DMRS, a method of indicating the SL TCI identifier is as follows: The transmitting end UE sends first indication information to the receiving end UE, where the first indication information indicates an SL TCI identifier of the PSSCH DMRS and/or the PSCCH DMRS, the first indication information is carried in M bits in second-stage SCI, and M is a positive integer. The receiving end UE determines the SL TCI identifier of the PSSCH DMRS and/or the PSCCH DMRS by using the first indication information. For M, refer to the record in the procedure in FIG. 7, and details are not described herein again.

In response to the first RS being an SL CSI-RS, a method of indicating the SL TCI identifier is as follows: The transmitting end UE configures an SL CSI-RS pattern (pattern), and sends first indication information to the receiving end UE, where the indication information indicates an SL TCI identifier of a first SL CSI-RS, the first indication information is carried in M bits in second-stage SCI, and M is a positive integer. The receiving end UE determines the SL TCI identifier of the SL CSI-RS by using the first indication information.

In response to the first RS being an S-SSB, the SL TCI identifier is indicated by using an implicit method. The transmitting end UE adds an SL TCI identifier of the S-SSB to an initialization parameter cᵢₙᵢₜ of a sequence of a PSBCH DMRS or an initialization parameter cᵢₙᵢₜ of a scrambling (scrambling) sequence of encoded bits (encoded bits) on a PSBCH. For a specific carrying manner, refer to the record in the procedure shown in FIG. 8, and details are not described herein again.

S903: The transmitting end UE sends the first RS to the receiving end UE.

The transmitting end UE simultaneously performs step S902 and step S903. To be specific, the transmitting end UE simultaneously sends, to the receiving end UE, the first RS and the first indication information that indicates the SL TCI identifier of the first RS. Alternatively, the transmitting end UE performs step S902 and step S903 in sequence. For example, the transmitting end UE first performs step S902 and then perform step S903, or the transmitting end UE first performs step S903 and then perform step S902. This is not limited.

S904: The receiving end UE determines the SL TCI identifier of the first RS based on the first indication information from the transmitting end UE.

A TCI framework in a Uu interface is constructed based on definitions of a TCI-state and QCL in the Uu air interface. A method of configuring and indicating the TCI-state in the Uu air interface is provided by using RRC signaling, a MAC CE, and DCI. The TCI framework in the Uu air interface is excessively flexible for a PC5 interface. A manner of configuring and indicating the TCI framework is complex. RRC signaling and a MAC CE that are used do not exist in the PC5 interface. Signaling overheads are high. In at least one embodiment, a new SL TCI identifier is defined for the PC5 interface, and a proper configuration and indication method is used. The SL TCI identifier is configured and indicated by using higher layer signaling and physical layer control information in the PC5 interface, so that signaling overheads are reduced.

Based on the foregoing method of configuring and indicating the SL TCI identifier, at least one embodiment provides a panel selection method, a beam selection method, or an antenna selection method. The method resolves a technical problem that there is no panel selection method, beam selection method, or antenna selection method in an SL. An example in which a first terminal apparatus is transmitting end UE and a second terminal apparatus is receiving end UE is used for description.

A principle of the method is as follows: Channel features experienced by RSs sent by different panels, beams, or antennas are different, so that in response an SL TCI identifier identifying different channel features, the SL TCI identifier further identifies different panels, beams, or antennas. The receiving end UE measures the reference signals sent by the different panels, beams, or antennas, and feed back a measurement result and a corresponding SL TCI identifier. The transmitting end UE selects a panel, a beam, or an antenna based on the measurement result. For example, the transmitting end UE selects an antenna, a beam, a panel, or the like that corresponds to an SL TCI identifier corresponding to a best measurement result.

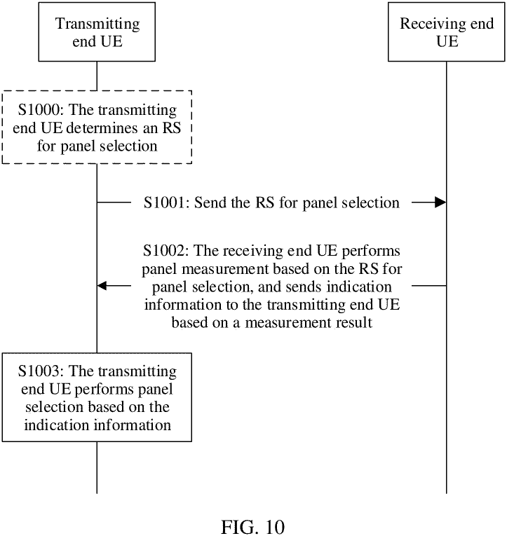

In at least one embodiment, the transmitting end UE has K candidate panels or candidate beams, where K is a positive integer. Optionally, in response to there being one antenna on a panel, the K candidate panels are equivalent to K candidate antennas. In the following embodiments, panel selection in which a panel is used as a candidate object is used as an example to describe procedures in at least one embodiment. In addition to the panel, the actual candidate object alternatively is a beam, an antenna, or the like. As shown in FIG. 10, the procedure includes the following steps.

Optionally, S1000: Transmitting end UE determines an RS for panel selection.

In at least one embodiment, the transmitting end UE determines that the RS for panel selection is an SL CSI-RS. Optionally, the transmitting end UE configures an SL CSI-RS pattern; and send indication information to receiving end UE. The indication information is for configuring the SL CSI-RS pattern. Alternatively, the transmitting end UE determines that the RS for panel selection is an S-SSB.

The foregoing step S1000 is an optional step, that is, the transmitting end UE skips determining the RS for panel selection. In this case, the RS for panel selection is defined in a standard, configured in a resource pool, preconfigured by the transmitting end UE, or the like. This is not limited.

S1001: The transmitting end UE sends, to the receiving end UE, the RS for panel selection.

In at least one embodiment, the RS for panel selection is an SL CSI-RS. The transmitting end UE sends the SL CSI-RS and first indication information to the receiving end UE. The first indication information indicates an SL TCI identifier of the SL CSI-RS. For example, the transmitting end UE sends the first indication information and the SL CSI-RS to the receiving end UE in the n^{th} slot of N^{slot} slots by using the k^{th} panel. N^{slot} is a positive integer, n is an integer satisfying 0 ≤n ≤N^{slot} - 1 , k is an integer satisfying 0 ≤k ≤K - 1, the first indication information indicates an SL TCI identifier n^{SL-TCI} of an SL CSI-RS sent in the n^{th} slot, n^{SL-TCI} is an integer satisfying 0 ≤n^{SL-TCI} ≤N^{SL-TCI} - 1, and N^{SL-TCI} is a positive integer greater than or equal to K. The receiving end UE receives the first indication information and the SL CSI-RS from the transmitting end UE in the N^{slot} slots. In addition, the receiving end UE determines the SL TCI identifier of the SL CSI-RS by using the first indication information.

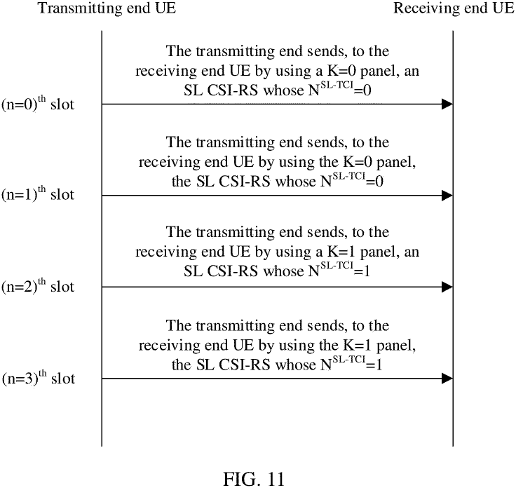

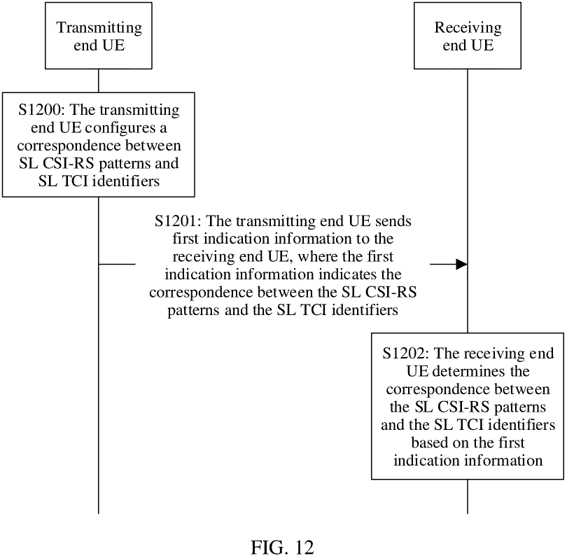

For example, as shown in FIG. 11, transmitting end UE has K = 2 candidate panels, and SL TCI identifiers n^{SL-TCI} corresponding to the two candidate panels are 0 and 1 respectively. The transmitting end UE separately sends an SL CSI-RS by using N^{slot} = 4 slots.

For example, the transmitting end UE sends, by using a panel 0 in the 0^{th} slot and the 1^{st} slot, an SL CSI-RS whose SL TCI identifier is 0. The transmitting end UE sends, by using a panel 1 in the 2^{nd} slot and the 3^{rd} slot, an SL CSI-RS whose SL TCI identifier is 1.

In at least one embodiment, the RS for panel selection is an S-SSB. The transmitting end UE sends the S-SSB to the receiving end UE, where the S-SSB carries first indication information indicating an SL TCI identifier. For example, the transmitting end UE sends the S-SSB to the receiving end UE in the n^{th} slot of N^{slot} slots by using the k^{th} panel, where the S-SSB includes the first indication information. N^{slot} is a positive integer, n is an integer satisfying 0 ≤n ≤N^{slot} - 1, k is an integer satisfying 0 ≤k ≤K - 1, the first indication information indicates an SL TCI identifier, namely, n^{SL-TCI}, of the S-SSB sent in the n^{th} slot, n^{SL-TCI} is an integer satisfying 0 ≤n^{SL-TCI} ≤N^{SL-TCI} - 1, and N^{SL-TCI} is a positive integer greater than or equal to K. The receiving end UE receives the S-SSB from the transmitting end UE in the N^{slot} slots. The S-SSB includes the first indication information. The receiving end UE determines the SL TCI identifier of the S-SSB by using the first indication information.

The “slot” in this embodiment of this application is a time unit used to transmit downlink information, uplink information, or SL information. Optionally, one slot includes 14 or 12 OFDM symbols. In an NR system, for different subcarrier spacings (subcarrier spacings, SCSs), one frame (frame) also includes different quantities of slots. Duration of one frame is set to 10 ms. If a normal cyclic prefix (normal cyclic prefix, NCP) is used, is response to an SCS being 15 kHz, a 10 ms frame includes 10 slots, and a slot corresponds to 1 ms; in response to an SCS being 30 kHz, a 10 ms frame includes 20 slots, and a slot corresponds to 0.5 ms; in response to an SCS being 60 kHz, a 10 ms frame includes 40 slots, and a slot corresponds to 0.25 ms; or in response to an SCS being 120 kHz, a 10 ms frame includes 80 slots, and a single slot corresponds to 0.125 ms. Alternatively, in response to an extended cyclic prefix (extended cyclic prefix, ECP) being used, a configuration in which an SCS is 60 kHz, a 10 ms frame includes 40 slots, and a slot corresponds to 0.25 ms is supported.

S1002: The receiving end UE measures the RS for panel selection, and sends second indication information to the transmitting end UE based on a measurement result. Optionally, the second indication information is carried in one or more MAC CEs.

S1003: The transmitting end UE performs panel selection based on the second indication information.

In at least one embodiment, after receiving RSs sent by using different panels, the receiving end UE separately measures the RSs to obtain measurement results. The receiving end UE sends the second indication information to the transmitting end UE. The second indication information indicates different measurement results and an SL TCI identifier corresponding to a measurement result. After receiving the different measurement results, the transmitting end UE selects a measurement result satisfying a condition, and uses, as a selected panel, a panel corresponding to an SL TCI identifier corresponding to the measurement result satisfying the condition. Optionally, the transmitting end UE subsequently transmits data with the receiving end UE by using the selected panel. Alternatively, the receiving end UE directly selects, based on the measurement results of the different RSs, the measurement result satisfying the condition. Then, the second indication information sent by the receiving end UE to the transmitting end UE carries the SL TCI identifier corresponding to the measurement result satisfying the condition. The receiving end UE uses, as a selected panel, a panel corresponding to the SL TCI identifier carried in the second indication information.

The example in FIG. 11 is still used. The transmitting end UE has two panels, which are respectively a panel 0 and a panel 1. The transmitting end UE uses the panel 0 to send an SL CSI-RS in the 0^{th} slot, and an SL TCI identifier corresponding to the panel 0 is 0. The transmitting end UE uses the panel 1 to send an SL CSI-RS in the 1^{st} slot, and an SL TCI identifier corresponding to the panel 1 is 1. The receiving end UE measures the SL CSI-RS sent in the 0^{th} slot, to obtain a channel measurement result 0. Similarly, the receiving end UE also measures the SL CSI-RS sent in the 1^{st} slot, to obtain a channel measurement result 1. The receiving end UE separately feeds back the channel measurement results of the foregoing two SL CSI-RSs and an SL TCI identifier corresponding to a channel measurement result to the transmitting end UE. Then, in S1003, the receiving end UE performs panel selection based on the channel measurement results of the CSI-RSs. For example, in response to the channel measurement result corresponding to the CSI-RS sent by using the panel 0 being better, the transmitting end UE subsequently selects the panel 0 to communicate with the receiving end UE. Alternatively, the foregoing panel selection process occurs on a receiving end UE side. The receiving end UE directly selects a panel based on an RS measurement result, and subsequently, the second indication information in S1002 carries an SL TCI identifier of the selected panel.

After selecting an RS, the transmitting end UE sends the RS on different panels for a plurality of times, and for sending, the receiving end UE feeds back a measurement result. Therefore, in the procedure shown in FIG. 10, S1001 and S1002 are cyclically performed. For example, the RS that is determined by the transmitting end UE and that is for panel selection is an SL CSI-RS. The transmitting end UE has two panels. In this case, the transmitting end UE separately sends the SL CSI-RS on the two panels. In addition, for a CSI-RS, the receiving end UE feeds back a measurement result. For example, in at least one embodiment, an execution sequence of the foregoing processes is: The transmitting end UE sends an SL CSI-RS 0 to the receiving end UE by using the panel 0, and the receiving end UE feeds back a measurement result of the CSI-RS 0. The transmitting end UE transmits an SL CSI-RS 1 to the receiving end UE by using the panel 1, and the receiving end UE feeds back a measurement result of the CSI-RS 1. Alternatively, the transmitting end UE respectively sends the CSI-RS 0 and the CSI-RS 1 to the receiving end UE by using the panel 0 and the panel 1. Then, the receiving end UE separately feeds back measurement results of the CSI-RS 0 and the CSI-RS 1. This is not limited.

In a Uu air interface, a TCI framework in the Uu air interface is constructed by using definitions of a TCI-state and QCL, and panel selection or beam selection is implemented by using the TCI framework. However, the TCI framework in the Uu air interface cannot be applied to an SL due to high signaling overheads and absence of signaling in a PC5 interface. In the foregoing embodiment, selection of a panel, a beam, or an antenna in the SL is implemented according to the proposed method of configuring and indicating the SL TCI identifier..

As shown in FIG. 12, a method of indicating an SL TCI identifier is provided. In the following embodiment, an example in which a first terminal apparatus is transmitting end UE and a second terminal apparatus is receiving end UE is used for description. A principle of the method is: A plurality of SL CSI-RS patterns are preconfigured for the transmitting end UE and the receiving end UE. SL CSI-RS patterns sent by using different panels, beams, or antennas is different. Therefore, there is a correspondence between the SL CSI-RS pattern and an SL TCI identifier. There is a one-to-one relationship between the SL CSI-RS pattern and the SL TCI identifier, that is, one SL CSI-RS pattern corresponds to one SL TCI identifier. Alternatively, there is a many-to-one relationship between the SL CSI-RS pattern and the SL TCI identifier, that is, a plurality of SL CSI-RS patterns correspond to one SL TCI identifier. Refer to FIG. 12. The method includes the following steps.

S1200: The transmitting end UE configures a correspondence between N^{CSI-RS} SL CSI-RS patterns and N^{SL-TCI} SL TCI identifiers. N^{CSI-RS} is a positive integer greater than or equal to 2, and N^{SL-TCI} is a positive integer less than or equal to N^{CSI-RS.}

S1201: The transmitting end UE sends first indication information to the receiving end UE, where the first indication information indicates the correspondence between the N^{CSI-RS} SL CSI-RS patterns and the N^{SL-TCI} SL TCI identifiers. Correspondingly, the receiving end UE receives the first indication information from the transmitting end UE. Optionally, the first indication information is carried in PC5-RRC signaling. Optionally, the N^{CSI-RS} SL CSI-RS patterns are configured for panel selection or beam selection.

S1202: The receiving end UE determines the correspondence between the N^{CSI-RS} SL CSI-RS patterns and the N^{SL-TCI} SL TCI identifiers based on the first indication information.

After S1202, the transmitting end UE directly sends an SL CSI-RS to a terminal device. After receiving the first SL CSI-RS, the receiving end UE determines, based on the configured correspondence between the N^{CSI-RS} SL CSI-RS patterns and the N^{SL-TCI} SL TCI identifiers, an SL TCI identifier corresponding to a pattern of the first SL CSI-RS.

According to the foregoing method, a method of indicating SL TCI identifiers of a plurality of SL CSI-RS patterns is proposed. The transmitting end UE preconfigures the correspondence between the SL CSI-RS patterns and the SL TCI identifiers for the receiving end UE, and subsequently, the transmitting end UE does not additionally indicate an SL TCI identifier of an SL CSI-RS pattern, so that signaling overheads are reduced.

Based on the foregoing method of indicating the SL TCI identifier, a method of panel selection, beam selection, or antenna selection is provided. In the following embodiment, an example in which a first terminal apparatus is transmitting end UE and a second terminal apparatus is receiving end UE is used for description.

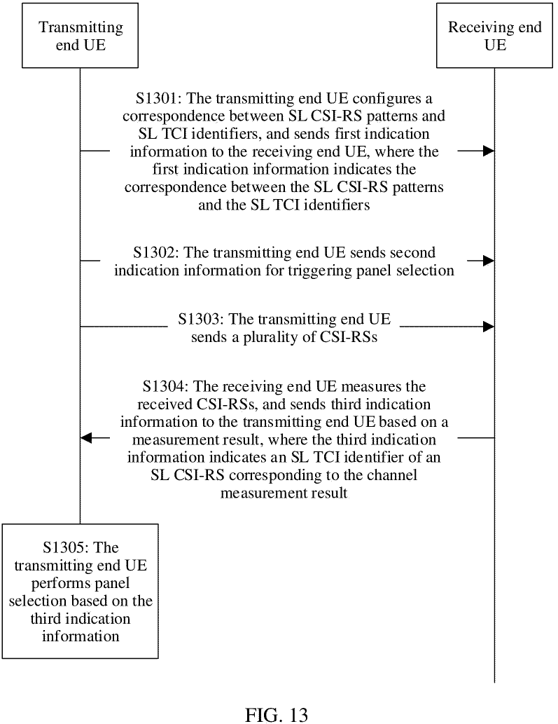

Similarly, in this example, the transmitting end UE has K candidate panels or candidate beams, where K is a positive integer. Optionally, in response to there being one antenna on a panel, the candidate panel is equivalent to a candidate antenna. In at least one embodiment, an example in which a panel is used as a candidate object for panel selection is used for description. In addition to the panel, the actual candidate object alternatively is a beam, an antenna, or the like. As shown in FIG. 13, the procedure includes the following steps.

S1301: The transmitting end UE configures a correspondence between N^{CSI-RS} SL CSI-RS patterns and N^{SL-TCI} SL TCI identifiers,

The transmitting end UE sends first indication information to the receiving end UE, where the first indication information indicates the correspondence between the N^{CSI-RS} SL CSI-RS patterns and the N^{SL-TCI} SL TCI identifiers.

S1302: The transmitting end UE triggers panel selection.

In at least one embodiment, the transmitting end UE sends second indication information to the receiving end UE, where the second indication information indicates that the transmitting end UE triggers panel selection, the second indication information is carried in M′ bits in second-stage SCI, and M′ is a positive integer. Optionally, M′ = 1.

S1303: The transmitting end UE sends, to the receiving end UE, the SL CSI-RS identifiers corresponding to the N^{CSI-RS} SL CSI-RS patterns.

In at least one embodiment, the transmitting end UE simultaneously sends, by using kₙ panels in the n^{th} slot of N^{slot} slots, SL CSI-RSs corresponding to gₙ SL CSI-RS patterns. N^{slot} is a positive integer, n is an integer satisfying 0 ≤n ≤N^{slot} - 1, kₙ is a positive integer less than or equal to K, kₙ satisfies

$$\sum {}_{\text{n=0}}^{{\text{N}}^{\text{slot}} {}_{- 1}} {k}_{n} = K$$

, gₙ is a positive integer less than or equal to N^{CSI-RS}, and gₙ satisfies

$$\sum {{}_{\text{n} = 0}^{{\text{N}}^{\text{slot}}}}^{- 1} {g}_{n} \geq {N}^{C S I - R S}$$

. The receiving end UE receives, in the N^{CSI-RS} slots, the SL CSI-RSs that are from the transmitting end UE and that correspond to the N^{CSI-RS} SL CSI-RS patterns. The receiving end UE determines an SL TCI identifier of an SL CSI-RS based on the N^{CSI-RS} SL CSI-RS patterns.

S1304: The receiving end UE measures the received CSI-RSs to obtain a measurement result, and sends third indication information to the transmitting end UE based on the measurement result, where the third indication information indicates an SL TCI identifier of a CSI-RS corresponding to the channel measurement result. Correspondingly, the transmitting end UE receives the third indication information from the receiving end UE. Optionally, the third indication information is carried in one or more MAC CEs.

S1305: The transmitting end UE performs panel selection based on the third indication information.

In at least one embodiment, the transmitting end UE sends RSs on different panels, antennas, or beams, the receiving end UE measures the RSs and performs feedback, and the transmitting end UE performs panel selection based on a fed-back measurement result. This resolves a technical problem that there is no panel selection method, antenna selection method, or beam selection method in an SL. Further, compared with the procedure shown in FIG. 10, in the current solution, panel selection, antenna selection, or beam selection is completed by using fewer slots, so that selection efficiency is improved. In addition, the second-stage SCI is not used to indicate the SL TCI identifier, so that signaling overheads are reduced.

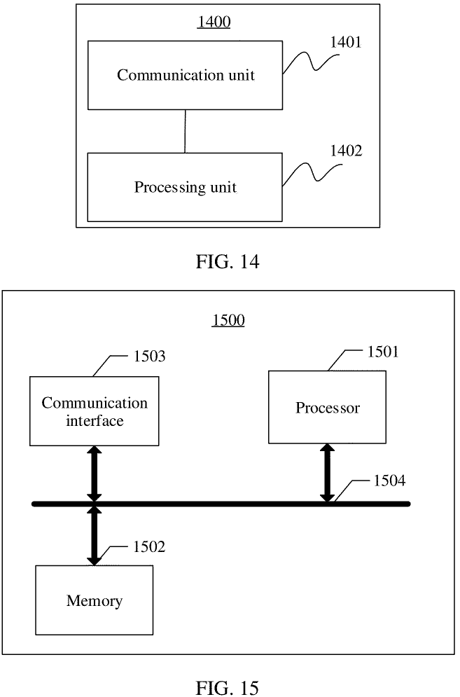

The foregoing describes in detail the methods provided in at least one embodiment with reference to FIG. 1 to FIG. 13. The following describes in detail apparatuses provided in at least one embodiment with reference to FIG. 14 and FIG. 15. Descriptions of the apparatus embodiments correspond to descriptions of the method embodiments. Therefore, for content that is not described in detail, refer to the descriptions in the foregoing method embodiments.

FIG. 14 is a schematic block diagram of an apparatus 1400 according to at least one embodiment. The apparatus 1400 is configured to implement functions of the first terminal apparatus or the second terminal apparatus in the foregoing methods. The apparatus is a software unit or a chip system. The system includes a chip, or includes a chip and another discrete device. The apparatus includes a communication unit 1401, and further includes a processing unit 1402. The communication unit 1401 communicates with the outside. The processing unit 1402 is configured to perform processing, The communication unit 1401 is also referred to as a communication interface, a transceiver unit, an input/output interface, or the like.

In an example, the apparatus 1400 implements the steps performed by the first terminal apparatus in the procedure shown in FIG. 7. The apparatus 1400 is a terminal device, or is a chip, a circuit, or the like configured in the terminal device. The communication unit 1401 performs receiving and sending operations of the first terminal apparatus in the foregoing method embodiments, and the processing unit 1402 performs processing-related operations of the first terminal apparatus in the foregoing method embodiments.

For example, the processing unit 1402 is configured to generate first indication information and a first reference signal. The communication unit 1401 is configured to send the first indication information to a second terminal apparatus, where the first indication information indicates a first sidelink transmission configuration indication SL TCI identifier of the first reference signal, and the first SL TCI identifier indicates a channel feature of a first channel for transmitting the first reference signal. The communication unit 1401 is further configured to send the first reference signal to the second terminal apparatus on the first channel.

Optionally, the first reference signal includes a physical sidelink shared channel demodulation reference signal, a physical sidelink control channel demodulation reference signal, or a sidelink channel state information reference signal, and the first indication information is carried in second-stage sidelink control information.

Optionally, the processing unit 1402 is further configured to determine N^{SL-TCI} SL TCI identifiers. N^{SL-TCI} is a positive integer greater than or equal to 1, and the first SL TCI identifier belongs to the N^{SL-TCI} SL TCI identifiers. The communication unit 1401 is configured to

send first configuration information to the second terminal apparatus. The first configuration information is for configuring the N^{SL-TCI} SL TCI identifiers for the second terminal apparatus.

Optionally, in response to determining the N^{SL-TCI} SL TCI identifiers, the processing unit 1402 is specifically configured to determine the N^{SL-TCI} SL TCI identifiers based on a quantity of panels, transmission beams, or antennas of a first terminal apparatus.

Optionally, the first configuration information is carried in a radio resource control message of a PC5 interface, or the first configuration information is carried in a media access control (MAC) control element of a PC5 interface.

Optionally, the processing unit 1402 is further configured to determine N^{SL-TCI} SL TCI identifiers based on configuration information of a sending resource pool. N^{SL-TCI} is a positive integer greater than or equal to 1, and the first SL TCI identifier belongs to the N^{SL-TCI} SL TCI identifiers.

In an example, the apparatus 1400 implements the steps performed by the second terminal apparatus in the procedure shown in FIG. 7. The apparatus 1400 is a terminal device, or is a chip, a circuit, or the like configured in the terminal device. The communication unit 1401 performs receiving and sending operations of the second terminal apparatus in the foregoing method embodiments, and the processing unit 1402 performs processing-related operations of the second terminal apparatus in the foregoing method embodiments.

For example, the communication unit 1401 is configured to receive first indication information from a first terminal apparatus. The first indication information indicates a first sidelink transmission configuration indication SL TCI identifier of a first reference signal, and the first SL TCI identifier indicates a channel feature of a first channel for transmitting the first reference signal. The communication unit 1401 is further configured to receive the first reference signal from the first terminal apparatus on the first channel. The processing unit 1402 is configured to process the first indication information and the first reference signal.

Optionally, the first reference signal includes a physical sidelink shared channel demodulation reference signal, a physical sidelink control channel demodulation reference signal, or a sidelink channel state information reference signal, and the first indication information is carried in second-stage sidelink control information.

Optionally, the communication unit 1401 is further configured to receive first configuration information from the first terminal apparatus. The first configuration information is for configuring N^{SL-TCI} SL TCI identifiers for a second terminal apparatus, and the first SL TCI identifier belongs to the N^{SL-TCI} SL TCI identifiers. The processing unit 1402 is configured to determine the N^{SL-TCI} SL TCI identifiers based on the first configuration information.

Optionally, the first configuration information is carried in a radio resource control message of a PC5 interface, or the first configuration information is carried in a media access control (MAC) control element of a PC5 interface.

Optionally, the processing unit 1402 is further configured to determine N^{SL-TCI} SL TCI identifiers based on configuration information of a receiving resource pool. N^{SL-TCI} is a positive integer greater than or equal to 1, and the first SL TCI identifier belongs to the N^{SL-TCI} SL TCI identifiers.

In an example, the apparatus 1400 implements the steps performed by the first terminal apparatus in the procedure shown in FIG. 8. The apparatus 1400 is a terminal device, or is a chip, a circuit, or the like configured in the terminal device. The communication unit 1401 performs receiving and sending operations of the first terminal apparatus in the foregoing method embodiments, and the processing unit 1402 performs processing-related operations of the first terminal apparatus in the foregoing method embodiments.

For example, the processing unit 1402 is configured to determine a first sidelink transmission configuration indication SL TCI identifier of a first signal. The first SL TCI identifier indicates a channel feature of a first channel for transmitting the first signal. The processing unit 1402 is further configured to determine the first signal based on the first SL TCI identifier. The communication unit 1401 is configured to send the first signal to a second terminal apparatus on the first channel.

Optionally, the first signal is a sidelink synchronization signal block, the sidelink synchronization signal block includes a physical sidelink broadcast channel demodulation reference signal, and an initialization parameter of a sequence of the physical sidelink broadcast channel demodulation reference signal is determined based on the first SL TCI identifier.

Optionally, the initialization parameter of the sequence of the physical sidelink broadcast channel demodulation reference signal satisfies:

$${\text{c}}_{\text{init}} = {2}^{11} \left({\overline{\text{i}}}_{\text{S-SSB}} \text{} + \text{} 1\right) \left({\text{N}}_{\text{SL}}^{\text{ID}} + 1\right) + {2}^{6} \left({\overline{\text{i}}}_{\text{S-SSB}} \text{} + \text{}\right) + {\text{n}}^{\text{SL-TCI}}$$

cᵢₙᵢₜ represents the initialization parameter of the sequence of the physical sidelink broadcast channel demodulation reference signal, i̅_{S-SSB} represents an integer value obtained based on an index of the sidelink synchronization signal block,

$${N}_{\text{SL}}^{\text{ID}}$$

represents a sidelink synchronization signal identifier, n^{SL-TCI} represents the first SL TCI identifier, and n^{SL-TCI} is a natural number.

Obtaining i̅_{S-SSB} based on the index of the sidelink synchronization signal block satisfies: i̅_{S-SSB} = i_{S-SSB} mod 2^{U}· i_{S-SSB} represents the index of the sidelink synchronization signal block, U is an integer greater than or equal to 0, and mod represents a modulo operation.

Optionally, the initialization parameter of the sequence of the physical sidelink broadcast channel demodulation reference signal satisfies:

$${\text{c}}_{\text{init}} = {2}^{\text{M}} {\text{N}}_{\text{SL}}^{\text{ID}} + {\text{n}}^{\text{SL} - \text{TCl}}$$

cᵢₙᵢₜ represents the initialization parameter of the sequence of the physical sidelink broadcast channel demodulation reference signal, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

Optionally, the first signal is a sidelink synchronization signal block, the sidelink synchronization signal block includes a physical sidelink broadcast channel, and an initialization parameter of a scrambling sequence of the physical sidelink broadcast channel is determined based on the first SL TCI identifier.

Optionally, the initialization parameter of the scrambling sequence of the physical sidelink broadcast channel satisfies:

$${\text{c}}_{\text{init}} = {2}^{\text{M}} {\text{N}}_{\text{SL}}^{\text{ID}} + {\text{n}}^{\text{SL} - \text{TCl}}$$

cᵢₙᵢₜ represents the initialization parameter of the scrambling sequence of the physical sidelink broadcast channel, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

Optionally, the processing unit 1402 is further configured to determine N^{SL-TCI} SL TCI identifiers. N^{SL-TCI} is a positive integer greater than or equal to 1, and the first SL TCI identifier belongs to the N^{SL-TCI} SL TCI identifiers. The communication unit 1401 is further configured to send first configuration information to the second terminal apparatus. The first configuration information is for configuring the N^{SL-TCI} SL TCI identifiers for the second terminal apparatus.

Optionally, in response to determining the N^{SL-TCI} SL TCI identifiers, the processing unit 1402 is specifically configured to determine the N^{SL-TCI} SL TCI identifiers based on a quantity of panels, transmission beams, or antennas of a first terminal apparatus.

Optionally, the first configuration information is carried in a radio resource control message of a PC5 interface, or the first configuration information is carried in a media access control (MAC) control element of a PC5 interface.

Optionally, the processing unit 1402 is further configured to determine N^{SL-TCI} SL TCI identifiers based on configuration information of a sending resource pool. N^{SL-TCI} is a positive integer greater than or equal to 1, and the first SL TCI identifier belongs to the N^{SL-TCI} SL TCI identifiers.

In an example, the apparatus 1400 implements the steps performed by the second terminal apparatus in the procedure shown in FIG. 8. The apparatus 1400 is a terminal device, or is a chip, a circuit, or the like configured in the terminal device. The communication unit 1401 performs receiving and sending operations of the second terminal apparatus in the foregoing method embodiments, and the processing unit 1402 performs processing-related operations of the second terminal apparatus in the foregoing method embodiments.

For example, the communication unit 1401 is configured to receive a first signal from a first terminal apparatus on a first channel. The processing unit 1402 is configured to determine a first sidelink transmission configuration indication SL TCI identifier based on the first signal. The first SL TCI identifier indicates a channel feature of the first channel for transmitting the first signal.

Optionally, the first signal is a sidelink synchronization signal block, the sidelink synchronization signal block includes a physical sidelink broadcast channel demodulation reference signal. In response to determining the first SL TCI identifier based on the first signal, the processing unit 1402 is specifically configured to determine the first SL TCI identifier based on an initialization parameter of a sequence of the physical sidelink broadcast channel demodulation reference signal.

Optionally, the initialization parameter of the sequence of the physical sidelink broadcast channel demodulation reference signal satisfies:

$${\text{c}}_{\text{init}} = {2}^{11} \left({\overline{\text{i}}}_{\text{S-SSB}} + 1\right) \left({\text{N}}_{\text{SL}}^{\text{ID}} + 1\right) + {2}^{6} \left({\overline{\text{i}}}_{\text{S-SSB}} + 1\right) + {\text{n}}^{\text{SL} - \text{TCI}}$$

cᵢₙᵢₜ represents the initialization parameter of the sequence of the physical sidelink broadcast channel demodulation reference signal, i̅_{S-SSB} represents an integer value obtained based on an index of the sidelink synchronization signal block,

$${N}_{\text{SL}}^{\text{ID}}$$

represents a sidelink synchronization signal identifier, n^{SL-TCI} represents the first SL TCI identifier, and n^{SL-TCI} is a natural number.

Obtaining i̅_{S-SSB} based on the index of the sidelink synchronization signal block satisfies: i̅_{S-SSB} mod 2^{U}· i_{S-SSB} represents the index of the sidelink synchronization signal block, U is an integer greater than or equal to 0, and mod represents a modulo operation.

Optionally, the initialization parameter of the sequence of the physical sidelink broadcast channel demodulation reference signal satisfies:

$${\text{c}}_{\text{init}} = {2}^{\text{M}} {\text{N}}_{\text{SL}}^{\text{ID}} + {\text{n}}^{\text{SL} - \text{TCI}}$$

cᵢₙᵢₜ represents the initialization parameter of the sequence of the physical sidelink broadcast channel demodulation reference signal, M is a positive integer,

$${\text{N}}_{\text{SL}}^{\text{ID}}$$

represents a sidelink synchronization signal identifier, n^{SL-TCI} represents the first SL TCI identifier, and n^{SL-TCI} is a natural number.

Optionally, the first signal is a sidelink synchronization signal block, the sidelink synchronization signal block includes a physical sidelink broadcast channel, and in response to determining the first SL TCI identifier based on the first signal, the processing unit 1402 is specifically configured to determine the first SL TCI identifier based on an initialization parameter of a scrambling sequence of the physical sidelink broadcast channel.

Optionally, the initialization parameter of the scrambling sequence of the physical sidelink broadcast channel satisfies:

$${\text{c}}_{\text{init}} = {2}^{\text{M}} {\text{N}}_{\text{SL}}^{\text{ID}} + {\text{n}}^{\text{SL} - \text{TCI}}$$

cᵢₙᵢₜ represents the initialization parameter of the scrambling sequence of the physical sidelink broadcast channel, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

Optionally, the communication unit 1401 is further configured to receive first configuration information from the first terminal apparatus. The first configuration information is for configuring N^{SL-TCI} SL TCI identifiers for a second terminal apparatus, and the first SL TCI identifier belongs to the N^{SL-TCI} SL TCI identifiers.

Optionally, the first configuration information is carried in a radio resource control message of a PC5 interface, or the first configuration information is carried in a media access control (MAC) control element of a PC5 interface.

Optionally, the processing unit 1402 is further configured to determine N^{SL-TCI} SL TCI identifiers based on a configuration of a receiving resource pool. N^{SL-TCI} is a positive integer greater than or equal to 1, and the first SL TCI identifier belongs to the N^{SL-TCI} SL TCI identifiers.

In at least one embodiment, division into the units is an example, is merely division into logical functions, and is other division during actual implementation. In addition, functional units in at least one embodiment is integrated into one processor, or the units exist alone physically, or two or more units is integrated into one unit. The integrated unit is implemented in a form of hardware, or is implemented in a form of a software functional unit.

In embodiments described herein, functions of the communication unit are implemented by a transceiver, and functions of the processing unit are implemented by a processor. The transceiver includes a transmitter and/or a receiver, to respectively implement functions of a sending unit and/or a receiving unit. Descriptions are provided below by way of example with reference to FIG. 15.

A communication apparatus 1500 shown in FIG. 15 includes at least one processor 1501. The communication apparatus 1500 further includes at least one memory 1502 configured to store program instructions and/or data. The memory 1502 is coupled to the processor 1501. The coupling in at least one embodiment is an indirect coupling or a communication connection between apparatuses, units, or modules, is in an electrical form, a mechanical form, or another form, and is used for information exchange between the apparatuses, the units, or the modules. The processor 1501 performs an operation cooperatively with the memory 1502. The processor 1501 executes the program instructions stored in the memory 1502. At least one of the at least one memory 1502 is included in the processor 1501.

The apparatus 1500 further includes a communication interface 1503. The communication interface 1503 is configured to communicate with another device through a transmission medium, so that the communication apparatus 1500 communicates with the another device. In at least one embodiment, the communications interface is a transceiver, a circuit, a bus, a module, or a communications interface of another type. In at least one embodiment, in response to the communication interface being the transceiver, the transceiver includes an independent receiver and an independent transmitter, or is a transceiver integrated with a transceiver function, or is an interface circuit.

A connection medium between the processor 1501, the memory 1502, and the communication interface 1503 is not limited in this embodiment of this application. In at least one embodiment, the memory 1502, the processor 1501, and the communication interface 1503 are connected through a communication bus 1504 in FIG. 15. The bus is represented by a thick line in FIG. 15. A connection manner between other components is merely an example for description, and is not limited. The bus includes an address bus, a data bus, a control bus, and the like. For ease of representation, in FIG. 15, one thick line is used for representation, but is able to represent one bus, one type of bus, or the like.

In an example, the apparatus 1500 is configured to implement the steps performed by the first terminal apparatus in the procedure shown in FIG. 7. The communication interface 1503 is configured to perform receiving and sending-related operations of the first terminal apparatus in the foregoing embodiments, and the processor 1501 is configured to perform processing-related operations of the first terminal apparatus in the foregoing method embodiments.

For example, the processor 1501 is configured to generate first indication information and a first reference signal. The communication interface 1503 is configured to send the first indication information to a second terminal apparatus, where the first indication information indicates a first sidelink transmission configuration indication SL TCI identifier of the first reference signal, and the first SL TCI identifier indicates a channel feature of a first channel for transmitting the first reference signal. The communication interface 1503 is further configured to send the first reference signal to the second terminal apparatus on the first channel.

Optionally, the first reference signal includes a physical sidelink shared channel demodulation reference signal, a physical sidelink control channel demodulation reference signal, or a sidelink channel state information reference signal, and the first indication information is carried in second-stage sidelink control information.

Optionally, the processor 1501 is further configured to determine N^{SL-TCI} SL TCI identifiers. N^{SL-TCI} is a positive integer greater than or equal to 1, and the first SL TCI identifier belongs to the N^{SL-TCI} SL TCI identifiers. The communication interface 1503 is configured to send first configuration information to the second terminal apparatus. The first configuration information is for configuring the N^{SL-TCI} SL TCI identifiers for the second terminal apparatus.

Optionally, in response to determining the N^{SL-TCI} SL TCI identifiers, the processor 1501 is specifically configured to determine the N^{SL-TCI} SL TCI identifiers based on a quantity of panels, transmission beams, or antennas of a first terminal apparatus.

Optionally, the first configuration information is carried in a radio resource control message of a PC5 interface, or the first configuration information is carried in a media access control (MAC) control element of a PC5 interface.

Optionally, the processor 1501 is further configured to determine N^{SL-TCI} SL TCI identifiers based on configuration information of a sending resource pool. N^{SL-TCI} is a positive integer greater than or equal to 1, and the first SL TCI identifier belongs to the N^{SL-TCI} SL TCI identifiers.

For example, the communication interface 1503 is configured to receive first indication information from a first terminal apparatus. The first indication information indicates a first sidelink transmission configuration indication SL TCI identifier of a first reference signal, and the first SL TCI identifier indicates a channel feature of a first channel for transmitting the first reference signal. The communication interface 1503 is further configured to receive the first reference signal from the first terminal apparatus on the first channel. The processor 1501 is configured to process the first indication information and the first reference signal.

Optionally, the first reference signal includes a physical sidelink shared channel demodulation reference signal, a physical sidelink control channel demodulation reference signal, or a sidelink channel state information reference signal, and the first indication information is carried in second-stage sidelink control information.

Optionally, the communication interface 1503 is further configured to receive first configuration information from the first terminal apparatus. The first configuration information is for configuring N^{SL-TCI} SL TCI identifiers for a second terminal apparatus, and the first SL TCI identifier belongs to the N^{SL-TCI} SL TCI identifiers. The processor 1501 is configured to determine the N^{SL-TCI} SL TCI identifiers based on the first configuration information.

Optionally, the first configuration information is carried in a radio resource control message of a PC5 interface, or the first configuration information is carried in a media access control (MAC) control element of a PC5 interface.

Optionally, the processor 1501 is further configured to determine N^{SL-TCI} SL TCI identifiers based on configuration information of a receiving resource pool. N^{SL-TCI} is a positive integer greater than or equal to 1, and the first SL TCI identifier belongs to the N^{SL-TCI} SL TCI identifiers.

In an example, the apparatus 1500 is configured to implement the steps performed by the second terminal apparatus in the procedure shown in FIG. 7. The communication interface 1503 is configured to perform receiving and sending-related operations of the second terminal apparatus in the foregoing embodiments, and the processor 1501 is configured to perform processing-related operations of the second terminal apparatus in the foregoing method embodiments.

For example, the communication interface 1503 is configured to receive first indication information from a first terminal apparatus. The first indication information indicates a first sidelink transmission configuration indication SL TCI identifier of a first reference signal, and the first SL TCI identifier indicates a channel feature of a first channel for transmitting the first reference signal. The communication interface 1503 is further configured to receive the first reference signal from the first terminal apparatus on the first channel. The processor 1501 is configured to process the first indication information and the first reference signal.

Optionally, the first reference signal includes a physical sidelink shared channel demodulation reference signal, a physical sidelink control channel demodulation reference signal, or a sidelink channel state information reference signal, and the first indication information is carried in second-stage sidelink control information.

Optionally, the communication interface 1503 is further configured to receive first configuration information from the first terminal apparatus. The first configuration information is for configuring N^{SL-TCI} SL TCI identifiers for a second terminal apparatus, and the first SL TCI identifier belongs to the N^{SL-TCI} SL TCI identifiers. The processor 1501 is configured to determine the N^{SL-TCI} SL TCI identifiers based on the first configuration information.

Optionally, the first configuration information is carried in a radio resource control message of a PC5 interface, or the first configuration information is carried in a media access control (MAC) control element of a PC5 interface.

Optionally, the processor 1501 is further configured to determine N^{SL-TCI} SL TCI identifiers based on configuration information of a receiving resource pool. N^{SL-TCI} is a positive integer greater than or equal to 1, and the first SL TCI identifier belongs to the N^{SL-TCI} SL TCI identifiers.

In an example, the apparatus 1500 is configured to implement the steps performed by the first terminal apparatus in the procedure shown in FIG. 8. The communication interface 1503 is configured to perform receiving and sending-related operations of the first terminal apparatus in the foregoing embodiments, and the processor 1501 is configured to perform processing-related operations of the first terminal apparatus in the foregoing method embodiments.

For example, the processor 1501 is configured to determine a first sidelink transmission configuration indication SL TCI identifier of a first signal. The first SL TCI identifier indicates a channel feature of a first channel for transmitting the first signal. The processor 1501 is further configured to determine the first signal based on the first SL TCI identifier. The communication interface 1503 is configured to send the first signal to a second terminal apparatus on the first channel.

Optionally, the first signal is a sidelink synchronization signal block, the sidelink synchronization signal block includes a physical sidelink broadcast channel demodulation reference signal, and an initialization parameter of a sequence of the physical sidelink broadcast channel demodulation reference signal is determined based on the first SL TCI identifier.

Optionally, the initialization parameter of the sequence of the physical sidelink broadcast channel demodulation reference signal satisfies:

$${\text{c}}_{\text{init}} = {2}^{11} \left({\overline{\text{i}}}_{\text{S-SSB}} \text{} + \text{} 1\right) \left({\text{N}}_{\text{SL}}^{\text{ID}} + 1\right) + {2}^{6} \left({\overline{\text{i}}}_{\text{S-SSB}} \text{} + \text{} 1\right) + {\text{n}}^{\text{SL-TCl}}$$

cᵢₙᵢₜ represents the initialization parameter of the sequence of the physical sidelink broadcast channel demodulation reference signal, i_{S-SSB} represents an integer value obtained based on an index of the sidelink synchronization signal block,

$${N}_{\text{SL}}^{\text{ID}}$$

represents a sidelink synchronization signal identifier, n^{SL-TCI} represents the first SL TCI identifier, and n^{SL-TCI} is a natural number.

Obtaining i̅_{S-SSB} based on the index of the sidelink synchronization signal block satisfies: i̅_{S-SSB} mod 2^{U}· i_{S-SSB} represents the index of the sidelink synchronization signal block, U is an integer greater than or equal to 0, and mod represents a modulo operation.

Optionally, the initialization parameter of the sequence of the physical sidelink broadcast channel demodulation reference signal satisfies:

$${\text{c}}_{\text{init}} = {2}^{\text{M}} {\text{N}}_{\text{SL}}^{\text{ID}} + {\text{n}}^{\text{SL-TCl}}$$

cᵢₙᵢₜ represents the initialization parameter of the sequence of the physical sidelink broadcast channel demodulation reference signal, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

Optionally, the first signal is a sidelink synchronization signal block, the sidelink synchronization signal block includes a physical sidelink broadcast channel, and an initialization parameter of a scrambling sequence of the physical sidelink broadcast channel is determined based on the first SL TCI identifier.

Optionally, the initialization parameter of the scrambling sequence of the physical sidelink broadcast channel satisfies:

$${\text{c}}_{\text{init}} = {2}^{\text{M}} {\text{N}}_{\text{SL}}^{\text{ID}} + {\text{n}}^{\text{SL} - \text{TCl}}$$

cᵢₙᵢₜ represents the initialization parameter of the scrambling sequence of the physical sidelink broadcast channel, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

Optionally, the processor 1501 is further configured to determine N^{SL-TCI} SL TCI identifiers. N^{SL-TCI} is a positive integer greater than or equal to 1, and the first SL TCI identifier belongs to the N^{SL-TCI} SL TCI identifiers. The communication interface 1503 is further configured to send first configuration information to the second terminal apparatus. The first configuration information is for configuring the N^{SL-TCI} SL TCI identifiers for the second terminal apparatus.

Optionally, in response to determining the N^{SL-TCI} SL TCI identifiers, the processor 1501 is specifically configured to determine the N^{SL-TCI} SL TCI identifiers based on a quantity of panels, transmission beams, or antennas of a first terminal apparatus.

Optionally, the first configuration information is carried in a radio resource control message of a PC5 interface, or the first configuration information is carried in a media access control (MAC) control element of a PC5 interface.

Optionally, the processor 1501 is further configured to determine N^{SL-TCI} SL TCI identifiers based on configuration information of a sending resource pool. N^{SL-TCI} is a positive integer greater than or equal to 1, and the first SL TCI identifier belongs to the N^{SL-TCI} SL TCI identifiers.

In an example, the apparatus 1500 is configured to implement the steps performed by the second terminal apparatus in the procedure shown in FIG. 8. The communication interface 1503 is configured to perform receiving and sending-related operations of the second terminal apparatus in the foregoing embodiments, and the processor 1501 is configured to perform processing-related operations of the second terminal apparatus in the foregoing method embodiments.

For example, the communication interface 1503 is configured to receive a first signal from a first terminal apparatus on a first channel. The processor 1501 is configured to determine a first sidelink transmission configuration indication SL TCI identifier based on the first signal. The first SL TCI identifier indicates a channel feature of the first channel for transmitting the first signal.

Optionally, the first signal is a sidelink synchronization signal block, the sidelink synchronization signal block includes a physical sidelink broadcast channel demodulation reference signal. In response to determining the first SL TCI identifier based on the first signal, the processor 1501 is specifically configured to determine the first SL TCI identifier based on an initialization parameter of a sequence of the physical sidelink broadcast channel demodulation reference signal.

Optionally, the initialization parameter of the sequence of the physical sidelink broadcast channel demodulation reference signal satisfies:

$${\text{c}}_{\text{init}} = {2}^{11} \left({\overline{\text{i}}}_{\text{S-SSB}} + 1\right) \left({\text{N}}_{\text{SL}}^{\text{ID}} + 1\right) + {2}^{6} \left({\overline{\text{i}}}_{\text{S-SSB}} + 1\right) + {\text{n}}^{\text{SL} - \text{TCI}}$$

cᵢₙᵢₜ represents the initialization parameter of the sequence of the physical sidelink broadcast channel demodulation reference signal, i̅_{S-SSB} represents an integer value obtained based on an index of the sidelink synchronization signal block,

$${N}_{\text{SL}}^{\text{ID}}$$

represents a sidelink synchronization signal identifier, n^{SL-TCI} represents the first SL TCI identifier, and n^{SL-TCI} is a natural number.

Obtaining i̅_{S-SSB} based on the index of the sidelink synchronization signal block satisfies: i̅_{S-SSB} mod 2^{U}. i_{S-SSB} represents the index of the sidelink synchronization signal block, U is an integer greater than or equal to 0, and mod represents a modulo operation.

Optionally, the initialization parameter of the sequence of the physical sidelink broadcast channel demodulation reference signal satisfies:

$${\text{c}}_{\text{init}} = {2}^{\text{M}} {\text{N}}_{\text{SL}}^{\text{ID}} + {\text{n}}^{\text{SL} - \text{TCI}}$$

cᵢₙᵢₜ represents the initialization parameter of the sequence of the physical sidelink broadcast channel demodulation reference signal, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

Optionally, the first signal is a sidelink synchronization signal block, the sidelink synchronization signal block includes a physical sidelink broadcast channel, and in response to determining the first SL TCI identifier based on the first signal, the processor 1501 being specifically configured to determine the first SL TCI identifier based on an initialization parameter of a scrambling sequence of the physical sidelink broadcast channel.

Optionally, the initialization parameter of the scrambling sequence of the physical sidelink broadcast channel satisfies:

$${\text{c}}_{\text{init}} = {2}^{\text{M}} {\text{N}}_{\text{SL}}^{\text{ID}} + {\text{n}}^{\text{SL} - \text{TCI}}$$

cᵢₙᵢₜ represents the initialization parameter of the scrambling sequence of the physical sidelink broadcast channel, M is a positive integer,

$${N}_{\text{SL}}^{\text{ID}}$$

represents a sidelink synchronization signal identifier, n^{SL-TCI} represents the first SL TCI identifier, and n^{SL-TCI} is a natural number.

Optionally, the communication interface 1503 is further configured to receive first configuration information from the first terminal apparatus. The first configuration information is for configuring N^{SL-TCI} SL TCI identifiers for a second terminal apparatus, and the first SL TCI identifier belongs to the N^{SL-TCI} SL TCI identifiers.

Optionally, the first configuration information is carried in a radio resource control message of a PC5 interface, or the first configuration information is carried in a media access control (MAC) control element of a PC5 interface.

Optionally, the processor 1501 is further configured to determine N^{SL-TCI} SL TCI identifiers based on a configuration of a receiving resource pool. N^{SL-TCI} is a positive integer greater than or equal to 1, and the first SL TCI identifier belongs to the N^{SL-TCI} SL TCI identifiers.

Further, at least one embodiment further provides an apparatus. The apparatus is configured to perform the methods in the foregoing method embodiments. A computer-readable storage medium is provided, including a program. In response to the program being executed by a processor, the methods in the foregoing method embodiments are performed. A computer program product is provided. The computer program product includes computer program code, and in response to the computer program code being run, a computer is enabled to perform the methods in the foregoing method embodiments. A chip is provided, including a processor. The processor is coupled to a memory. The memory is configured to store a program or instructions. In response to the program or the instructions being executed by the processor, an apparatus is enabled to perform the methods in the foregoing method embodiments.

In at least one embodiment, the processor is a general-purpose processor, a digital signal processor, an application-specific integrated circuit, a field programmable gate array or another programmable logic device, a discrete gate or transistor logic device, or a discrete hardware component. The processor implements or executes the methods, steps, and logical block diagrams disclosed in at least one embodiment. The general-purpose processor is a microprocessor or the like. The steps of the method disclosed with reference to at least one embodiment is directly performed by a hardware processor, or is performed by using a combination of hardware in the processor and a software module.

In at least one embodiment, the memory is a non-volatile memory, such as a hard disk drive (hard disk drive, HDD) or a solid-state drive (solid-state drive, SSD), or is a volatile memory (volatile memory), such as a random access memory (random access memory, RAM). The memory is any other medium that carries or stores expected program code in a form of an instruction or a data structure and that is accessed by a computer, but is not limited thereto. The memory in at least one embodiment is alternatively a circuit or any other apparatus that can implement a storage function, and is configured to store the program instructions and/or the data.

All or some of the methods in at least one embodiment is implemented by using software, hardware, firmware, or any combination thereof. In response to software being used to implement the embodiments, all or a part of the embodiments is implemented in a form of a computer program product. The computer program product includes one or more computer instructions. In response to the computer program instructions being loaded and executed on the computer, the procedure or functions according to embodiments of the present invention are all or partially generated. The computer is a general-purpose computer, a dedicated computer, a computer network, a network device, user equipment, or another programmable apparatus. The computer instructions is stored in a computer-readable storage medium or is transmitted from a computer-readable storage medium to another computer-readable storage medium. For example, the computer instructions is transmitted from a website, computer, server, or data center to another website, computer, server, or data center in a wired (for example, a coaxial cable, an optical fiber, or a digital subscriber line (digital subscriber line, DSL for short)) or wireless (for example, infrared, radio, or microwave) manner. The computer-readable storage medium is any usable medium accessible by a computer, or a data storage device, for example, a server or a data center, integrating one or more usable media. The usable medium is a magnetic medium (for example, a floppy disk, a hard disk, or a magnetic tape), an optical medium (for example, a digital video disc (digital video disc, DVD for short)), a semiconductor medium (for example, an SSD), or the like.

A person skilled in the art is able to make various modifications and variations without departing from the scope of embodiments described herein. Embodiments described herein are intended to cover these modifications and variations provided that they fall within the scope of protection defined by the following claims and their equivalent technologies.

What is claimed is:

1. A communication method, comprising:
sending, by a first terminal apparatus to a second terminal apparatus, first indication information for indicating a first sidelink transmission configuration indication (SL TCI) identifier of a first reference signal, and the first SL TCI identifier indicates a channel feature of a first channel for transmitting the first reference signal; and
sending, by the first terminal apparatus to the second terminal apparatus, the first reference signal on the first channel.

2. The method according to claim 1, wherein the first reference signal includes a physical sidelink shared channel demodulation reference signal, a physical sidelink control channel demodulation reference signal, or a sidelink channel state information reference signal, and the first indication information is carried in second-stage sidelink control information.

3. The method according to claim 1, wherein the method further comprises:
determining N^{SL-TCI} SL TCI identifiers, wherein N^{SL-TCI} is a positive integer greater than or equal to 1, and the first SL TCI identifier belongs to the N^{SL-TCI} SL TCl identifiers; and
sending first configuration information to the second terminal apparatus, wherein the first configuration information is for configuring the N^{SL-TCI} SL TCI identifiers for the second terminal apparatus.

4. The method according to claim 3, wherein the determining N^{SL-TCI} SL TCI identifiers includes:
determining the N^{SL-TCI} SL TCI identifiers based on a quantity of panels, transmission beams, or antennas of the first terminal apparatus.

5. The method according to claim 3, wherein the first configuration information is carried in a radio resource control message of a PC5 interface, or the first configuration information is carried in a media access control (MAC) control element of the PC5 interface.

6. A communication method, comprising:
receiving, at a first terminal apparatus, first indication information from a second terminal apparatus, wherein the first indication information indicates a first sidelink transmission configuration indication (SL TCI) identifier of a first reference signal, and the first SL TCI identifier indicates a channel feature of a first channel for transmitting the first reference signal; and
receiving, at the first terminal apparatus, the first reference signal from the second terminal apparatus on the first channel.

7. The method according to claim 6, wherein the first reference signal includes a physical sidelink shared channel demodulation reference signal, a physical sidelink control channel demodulation reference signal, or a sidelink channel state information reference signal, and the first indication information is carried in second-stage sidelink control information.

8. The method according to claim 6, wherein the method further comprises:
receiving, at the first terminal apparatus, first configuration information from the second terminal apparatus, wherein the first configuration information is for configuring N^{SL-TCI} SL TCI identifiers for the first terminal apparatus, and the first SL TCI identifier belongs to the N^{SL-TCI} SL TCl identifiers; and
determining the N^{SL-TCI} SL TCI identifiers based on the first configuration information.

9. The method according to claim 8, wherein the first configuration information is carried in a radio resource control message of a PC5 interface, or the first configuration information is carried in a media access control (MAC) control element of the PC5 interface.

10. The method according to claim 6, wherein the method further comprises:
determining N^{SL-TCI} SL TCI identifiers based on configuration information of a receiving resource pool, wherein N^{SL-TCI} is a positive integer greater than or equal to 1, and the first SL TCI identifier belongs to the N^{SL-TCI} SL TCI identifiers.

11. A terminal apparatus, comprising:
a memory storing computer-readable instructions;
a processor connected to the memory; and
a transmitter, coupled to the processor;
wherein the processor is configured to execute the computer-readable instructions to:
generate first indication information and a first reference signal, wherein
the first indication information indicates a first sidelink transmission configuration indication SL TCI identifier of the first reference signal, and the first SL TCI identifier indicates a channel feature of a first channel for transmitting the first reference signal; and
send, using the transmitter, the first indication information to a second terminal apparatus; and
send, using the transmitter, the first reference signal to the second terminal apparatus on the first channel.

12. The apparatus according to claim 11, wherein the first reference signal includes a physical sidelink shared channel demodulation reference signal, a physical sidelink control channel demodulation reference signal, or a sidelink channel state information reference signal, and wherein the processor is further configured to send the first indication information in second-stage sidelink control information.

13. The apparatus according to claim 11, wherein the processor is further configured to:
determine N^{SL-TCI} SL TCI identifiers, wherein N^{SL-TCI} is a positive integer greater than or equal to 1, and the first SL TCI identifier belongs to the N^{SL-TCI} SL TCl identifiers; and
send, using the transmitter, first configuration information to the second terminal apparatus, wherein the first configuration information is for configuring the N^{SL-TCI} SL TCI identifiers for the second terminal apparatus.

14. The apparatus according to claim 13, further comprising panels or antennas, wherein the antennas are configured to transmit using transmission beams, wherein the processor is further configured to determine the N^{SL-TCI} SL TCI identifiers by determining the N^{SL-TCI} SL TCI identifiers based on a quantity of the panels, the transmission beams formed by the antennas, or the antennas.

15. The apparatus according to claim 13, wherein the processor is further configured to send first configuration information in a radio resource control message of a PC5 interface, or in a media access control (MAC) control element of the PC5 interface.
